(19) United States
(12) Patent Application Publication
(10) Pub. No.: US 2009/0107520 A1
(43) Pub. Date: Apr. 30, 2009

(54) AMIDOXIME COMPOUNDS AS CHELATING AGENTS IN SEMICONDUCTOR PROCESSES

(76) Inventors: Wai Mun Lee, Fremont, CA (US); Mark A. Scialdone, West Grove, PA (US); Albert G. Anderson, Wilmington, DE (US)

Correspondence Address: MORGAN LEWIS & BOCKIUS LLP, 1111 PENNSYLVANIA AVENUE NW, WASHINGTON, DC, 20004, US

(21) Appl. No.: 12/260,358

(22) Filed: Oct. 29, 2008

Related U.S. Application Data
(60) Provisional application No. 61/000,727, filed on Oct. 29, 2007.

(51) Int. Cl. C23G 1/00; C11D 1/66

(52) U.S. Cl. 134/2; 510/433; 510/175; 510/176

(57) ABSTRACT

The present invention is a composition and cleaning method for use in semiconductor processes wherein the compositions comprises at least one amidoxime compound.

### BACKGROUND

A large number of complexing agents for metal ions are used in a wide variety of applications, such as: semiconductor cleaning, detergents and cleaners, electroplating, water treatment and polymerizations, the photographic industry, the textile industry, the papermaking industry, pharmaceuticals, cosmetics, foodstuffs and plant feeding.

Examples of complexing agents include, but are not limited to, nitrilotriacetic acid (NTA), ethylenediaminetetraacetic acid (EDTA), N,N′-bis(2-hydroxyphenyl)ethylenediiminodiacetic acid (HPED), triethylenetetranitrilohexaacetic acid (TTHA), desferriferrioxamin B, N,N′,N″-tris[2-(N-hydroxycarbonyl)ethyl]-1,3,5-benzenetricarboxamide (BAMTPH), ethylenediaminediorthohydroxyphenylacetic acid (EDDHA), ethylenediaminetetramethylenephosphonic acid (EDTMP), propylenediaminetetraacetic acid (PDTA), hydroxypropylenediaminetetraacetic acid (HPDTA), isoserinediacetic acid (ISDA), β-alaninediacetic acid (β-ADA), hydroxyethanediphosphonic acid, diethylenetriaminetetraacetic acid, diethylenetriaminetetramethylenephosphonic acid, hydroxyethyleneaminodiacetic acid, hydroxyethylethylenediaminetriacetic acid, diethylenetriaminepentaacetic acid, diethanolglycine, ethanolglycine, citric acid, glycolic acid, glyoxylic acid, lactic acid, phosphonic acid, glucoheptonic acid, tartaric acid, polyacrylates, carbonates, phosphonates and gluconates.

Semiconductor processing applications increasingly rely on chemistries containing complexing agents. In fact, more than one hundred steps are involved in a standard IC manufacturing process which involves wafer cleaning or surface preparation, including post-resist strip/ash residue removal, native oxide removal, and even selective etching. Although dry processes continue to evolve and offer unique advantages for some applications, most cleaning/surface prep processes are “wet,” and occasionally involve the use of chemicals that may present environmental challenges, such as hydrofluoric acid, hydrochloric acid, sulfuric acid, phosphoric acid or hydrogen peroxide. Due in part to environmental concerns, the use of more dilute chemistries has increased and has been aided by the use of some form of mechanical energy, such as megasonics or jet-spray processing. Accordingly, there is a need for chemistries that can be effectively used in diluted form.

In juxtaposition, cleaning needs and goals have become more demanding. Increasingly, wafers are being processed with a single-wafer approach, as compared to a batch immersion or batch spray system. The single-wafer approach requires fast and effective chemical cleaning. Further, in wafer cleaning applications, particle removal may not be the main objective. Other goals become the focus, such as removing native oxide or photoresist residue after strip/ash. Accordingly, there is a need for chemistries that can be used in both single-wafer and batch processing, while addressing a variety of goals in the removal process.

In some cases, the biodegradability of the complexing agents is also unsatisfactory. Thus, EDTA proves to have inadequate biodegradability in conventional tests, as does PDTA or HPDTA and corresponding aminomethylenephosphonates which, moreover, are often undesirable because of their phosphorus content. Phosphorus is also a dopant in semiconductor devices. Therefore it is desirable to have cleaning solutions with non-phosphorus containing compounds.

Most formulations being used for cleaning substrates containing metallic-etch residue removal, post-CMP cleaning, and other semiconductor applications, contain complexing agents, sometimes called chelating agents. Many metal-chelating functionalities are known which cause a central metal ion to be attached by coordination links to two or more nonmetal atoms (ligands) in the same molecule. Heterocyclic rings are formed as part of the coordination complex with the central (metal) atom as a member of each ring. When the complex becomes more soluble in the solution in which it is present, it functions as a cleaning process. If the complexed product is not soluble in the solution in which it is present, it becomes a passivating agent by forming an insoluble film on top of the metal surface. The complexing agents currently in commercial use, such as, glycolic acid, glyoxylic acid, lactic acid and phosphonic acid, are acidic in nature and have a tendency to attack the residue and remove both metals and metal oxides, such as, for example, copper and copper oxide. This undesired result presents a problem for formulators where a chelating function is sought but only selectively to metal oxide residues and not to the metal itself, e.g., in an application involving metal, such as copper. Accordingly, there is a need for complexing agents that are not aggressive toward metal substrates, but still effectively chelate unwanted metal ion residues created during manufacturing processes.

The present invention addresses these problems.

### SUMMARY OF THE INVENTION

One embodiment of the present invention involves the use of an aqueous composition comprising an amidoxime compound (i.e., a compound containing one or more amidoxime functional groups) in a semiconductor application wherein the amidoxime compound complexes with metal (or a metal oxide) on a surface, in a residue, or both. In an exemplary embodiment, the composition contains one or more organic solvents. In an exemplary embodiment, the composition contains one or more surfactants. In an exemplary embodiment, the composition contains one or more additional compounds that contain functional groups which complex or chelate with metals or metal oxides. Optionally, the composition contains one or more acids or bases. In an exemplary embodiment, the composition contains a compound which has oxidation and reduction potentials, such as hydroxylamine or a hydroxylamine derivative, such as a hydroxylamine salt or hydrogen peroxide.

The compositions of the invention may contain from about 0.1% to about 99.9% water and from about 0.01% to about 99.9% of one or more amidoxime compounds.

The amidoxime compounds may be used in combination with other chelating or complexing compounds such as, for example, hydroxamic acid, thiohydroxamic acid, N-hydroxyurea, N-hydroxycarbamate and N-nitroso-alkyl-hydroxylamine. The amidoxime compounds may be used in semiconductor manufacturing processes; including, but not limited to, as a complexing agent for removal of residues from semiconductor substrates and in CMP slurries.

In an exemplary embodiment, amidoxime compounds can be prepared by the reaction of nitriles (i.e., compounds containing a nitrile functional group) with hydroxylamine, as shown.

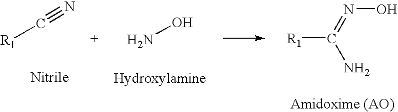

The amidoxime structure may also be represented in its resonance (or tautomeric) form as illustrated below.

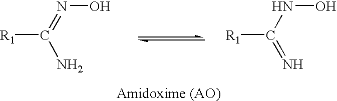

In an exemplary embodiment, the amidoxime compounds are prepared by the reaction of hydroxylamine with nitrite compounds. The nitrile compounds may be prepared by any known methods, including, but not limited to, cyanoethylation. Particular classes of compounds which are suitable to undergo cyanoethylation include, but are not limited to, the following: compounds containing one or more —OH or —SH groups, such as water, alcohols (e.g., phenols), oximes, and thiols (e.g., hydrogen sulphide); compounds containing one or more —NH— or —NH₂ groups (e.g., ammonia, primary and secondary amines, hydrazines, and amides); ketones or aldehydes possessing a —CH—, —CH₂—, or —CH₃ group adjacent to the carbonyl group; and compounds such as malonic esters, malonamide and cyanoacetamide, in which a —CH— or —CH₂— group is situated between —CO₂R, —CN, or —CONH— groups.

Listings of the above exemplary compounds can be found in the relevant tables of the CRC Handbook—Table for Organic Compound Identification, 3^{rd} Ed., published by The Chemical Rubber Company, with such tables being incorporated herein by reference.

Formulations containing amidoximes may optionally include other complexing agents and the amidoxime compounds themselves could contain other functional groups within the molecule that have a chelating functionality.

The compositions of the present application include semiconductor processing compositions comprising water and at least one amidoxime compound. In an exemplary embodiment, the amidoxime compound is prepared from a nitrile compound, either before its contact with the composition (i.e., pre-formed) or alternatively, during contact with the composition (i.e., in-situ formation).

In particular embodiments, the nitrile compound is derived from the cyanoethylation of a compound selected from the group consisting of sugar alcohols, hydroxy acids, sugar acids, monomeric polyols, polyhydric alcohols, glycol ethers, polymeric polyols, polyethylene glycols, polypropylene glycols, amines, amides, imides, amino alcohols, and synthetic polymers. In one embodiment of the invention, the synthetic polymers contain least one functional group that is —OH or —NHR, where R is H or alkyl, heteroalkyl, aryl or heteroaryl.

One exemplary embodiment of the invention is a method of applying a composition containing at least water and an amidoxime compound to a semiconductor substrate, comprising contacting the substrate with the composition. The composition may be applied to the semiconductor substrate as part of a CMP process, during a cleaning process and during a stripping process. Optionally, the pH is maintained to cause a passivating layer to form on the semiconductor substrate surface.

Another exemplary embodiment of the present invention is a process for preparing a semiconductor surface comprising: (a) forming an aqueous mixture of a cyanoethylation catalyst and an alcohol or amine; (b) adding an unsaturated nitrile to the aqueous mixture of the catalyst and alcohol or amine, and allowing the unsaturated nitrile to react with the alcohol or amine to form a first aqueous solution; (c) adding a source of hydroxylamine to the first aqueous solution of step (b) to form a second aqueous solution; and (d) applying the second aqueous solution to a semiconductor surface containing copper. In particular embodiments, the alcohol is sucrose or sorbitol. In exemplary embodiments, the amine is a primary or secondary amine having 1 to 30 carbon atoms, or is a polyethyleneamine. In particular embodiments, the source of hydroxylamine is hydroxylamine as the free base or a hydroxylamine salt, such as, for example, hydroxylamine hydrochloride or hydroxylamine sulfate. In exemplary embodiments, the cyanoethylation catalyst is an effective amount (typically catalytic) of a hydroxide base such as, for example, lithium hydroxide, sodium hydroxide, or potassium hydroxide. In a particular embodiment, the unsaturated nitrite is acrylonitrile.

Yet another exemplary embodiment is a process for preparing a semiconductor surface comprising: (a) forming an aqueous mixture of a cyanoethylation catalyst and a nucleophile containing an alcohol or amine functionality; (b) adding an unsaturated nitrile to the mixture of step (a) and allowing the unsaturated nitrile to react with the alcohol or amine functionality to form a first aqueous solution; (c) adding a source of hydroxylamine to the first aqueous solution of step (b) to form a second solution; and (d) applying the second solution to a semiconductor surface containing copper. The nucleophile alcohol may be sorbitol, sucrose, pentaerythritol, glycols and mixtures thereof. In one embodiment, the nucleophile is a primary or secondary amine having 1 to 30 carbon atoms. In another embodiment, the source of hydroxylamine is hydroxylamine free base, hydroxylamine hydrochloride, hydroxylamine phosphate or hydroxylamine sulfate. In yet another embodiment, the hydroxylamine free base is 50% solution in water. The cyanoethylation catalyst may be lithium hydroxide, sodium hydroxide, potassium hydroxide, or a tetraalkylammonium hydroxide (such as e.g. tetramethylammonium hydroxide (TMAH), TMAH pentahydrate, Benzyltrimethylammonium hydroxide (BTMAH) and tetrabutylammonium hydroxide (TBAH)). The unsaturated nitrite may be acrylonitrile.

Another exemplary embodiment of the present invention is a method of processing a wafer comprising: placing a wafer in a single wafer or batch cleaning tool and exposing the wafer to an aqueous cleaning solution comprising at least one amidoxime compound, wherein the wafer is exposed to the solution for an appropriate time, such as in the approximate range of 30 seconds to 90 seconds. In exemplary embodiments, the composition comprises water that is introduced as a constituent of the raw materials or components present in the composition. In exemplary embodiments, the amidoxime compound is present in the amount of about 0.001 to about 99 percent by weight. In exemplary embodiments, the cleaning solution optionally comprises an organic solvent in the amount of between 0 to about 99 percent by weight; an acid in the amount of about 0.001 to about 15 percent by weight; an activator in the amount of about 0.001 to about 25 percent by weight; optionally an additional chelating or complexing agent in the amount of between 0 to about 15 percent by weight; and a surfactant in an amount of about 10 ppm to about 5 percent by weight. In exemplary embodiments, the cleaning solution optionally comprises an organic solvent in the amount of between 0 to about 99 percent by weight; a base in the amount of about 1 to about 45 percent by weight; an activator in the amount of about 0.001 to about 25 percent by weight; optionally an additional chelating or complexing agent in the amount of 0 to about 15 percent by weight; and a surfactant in an amount of about 10 ppm to about 5 percent by weight. The cleaning solution comprising at least one amidoxime compound may be further diluted prior to use (e.g. by a factor of from about 10 to about 500).

Yet another exemplary embodiment of the invention is method of processing a wafer comprising placing a wafer in a single wafer or batch cleaning tool and exposing the wafer to a cleaning solution comprising at least one amidoxime compound. The wafer is exposed to the solution at a sufficient time (e.g. 30 second to 30 minutes) and temperature (e.g. ambient temperature to 100° C.) to effectively remove surface residue and contaminants created during semiconductor manufacturing process. The composition may contain water that is introduced as a constituent of components of the composition. The amidoxime compound may be present in an amount of about 0.001 to about 99 percent by weight. The cleaning solution may further comprise an organic solvent, an acid, an activator, additional chelating or complexing agents and/or a surfactant. In one embodiment, the cleaning solution further comprises an organic solvent in an amount up to about 99 percent by weight. In another embodiment, the cleaning solution further comprises an acid in an amount of about 0.001 to about 45 percent by weight. In yet another embodiment, the cleaning solution further comprises an activator in an amount of about 0.001 to about 25 percent by weight. In an alternate embodiment, the cleaning solution further comprises an additional chelating or complexing agent in an amount up to about 15 percent by weight. In yet another embodiment, the cleaning solution further comprises a surfactant in an amount of about 10 ppm to about 5 percent by weight. In an alternate embodiment, the cleaning solution further comprises an organic solvent in an amount up to about 99 percent by weight; a base in an amount of about 1 to about 45 percent by weight; an activator in an amount of about 0.001 to about 25 percent by weight; an additional chelating or complexing agent in an amount up to about 15 percent by weight and a surfactant in an amount of about 10 ppm to about 5 percent by weight.

Another exemplary embodiment of the invention is a method of cleaning a wafer comprising: placing a wafer in single wafer cleaning tool; cleaning said wafer with a solution comprising: water, a compound with an amidoxime group; an organic solvent in the amount of between 0 to about 99 percent by weight; a base in the amount of about 1 to about 45 percent by weight; a compound with oxidation and reduction potential in an amount of about 0.001 to about 25 percent by weight; an activator in the amount of about 0.001 to about 25 percent by weight; optionally an additional chelating or complexing agent in the amount of about 0 to about 15 percent by weight; a surfactant in an amount of about to ppm to about 5 percent by weight; and a fluoride ion source in an amount of about 0.001 to about 10 percent by weight.

Yet another exemplary embodiment of the invention is a method of cleaning a wafer having at least the steps of: placing a wafer in a cleaning tool (e.g. single wafer processing or batch processing tool); cleaning the wafer with a solution comprising: water, an amidoxime compound; an organic solvent in an amount up to about 99 percent by weight; optionally a base in an amount of about 1 to about 45 percent by weight; optionally a compound with an oxidation and reduction potential in an amount of about 0.001 to about 25 percent by weight; optionally an activator in an amount of about 0.001 to about 25 percent by weight; an additional chelating or complexing agent in an amount up to about 15 percent by weight; optionally a surfactant in an amount of about 10 ppm to about 5 percent by weight; and optionally a fluoride ion source in an amount of about 0.001 to about 10 percent by weight.

Another exemplary embodiment of the invention is a method of cleaning a wafer having at least the steps of: placing a wafer in a cleaning tool (e.g. a single wafer processing or batch processing tool); cleaning the wafer with a solution comprising: water, an amidoxime compound; an organic solvent in an amount up to about 99 percent by weight; optionally an acid in an amount of about 0.001 to about 15 percent by weight; optionally a compound with oxidation and reduction potential in an amount of about 0.001 to about 25 percent by weight; optionally an activator in an amount of about 0.001 to about 25 percent by weight; an additional chelating or complexing agent in an amount up to about 15 percent by weight; optionally a surfactant in an amount of about 10 ppm to about 5 percent by weight; and optionally a fluoride ion source in an amount of about 0.001 to about 10 percent by weight.

### DETAILED DESCRIPTION

An embodiment of the present invention relates to compositions containing one or more complexing agents or compounds having one or more multidentate chelating groups wherein at least one of the agents is an amidoxime compound. Such compositions exhibit improved performance in semiconductor applications, for example, in processes involving metals and metal oxides. In addition to the one or more amidoxime compounds, the compositions may optionally contain other chelating agents or compounds having chelating/complexing functional groups. Examples of such complexing agents include, but are not limited to, nitrilotriacetic acid (NTA), ethylenediaminetetraacetic acid (EDTA), ethylenediaminetetramethylenephosphonic acid (EDTMP), propylenediaminetetraacetic acid (PDTA), hydroxypropylenediaminetetraacetic acid (HPDTA), isoserinediacetic acid (ISDA), β-alaninediacetic acid (β-ADA), hydroxyethanediphosphonic acid, diethylenetriaminetetraacetic acid, diethylenetriaminetetramethylenephosphonic acid, hydroxyethyleneaminodiacetic acid, hydroxyethylethylenediaminetriacetic acid, diethylenetriaminepentaacetic acid, diethanolglycine, ethanolglycine, citric acid, glycolic acid, glyoxylic acid, lactic acid, phosphonic acid, glucoheptonic acid, catechol, gallic acid, tartaric acid, hydroxamic acid, thiohydroxamic acid, N-hydroxyurea, N-hydroxycarbamate and N-nitroso-alkyl-hydroxylamine compounds.

Surprisingly, it has been found that the addition of such compounds to residue removal, resist stripping, post-CMP clean, as an additive for CMP slurries, and other semiconductor applications, particularly where it is desired effectively to remove contaminants while having no negative effect on the substrate surfaces.

Without being bound to any particular theory, it is understood that the multidentate complexing agents described above complex with substrate surfaces to remove contaminants on such surfaces. Amidoxime compounds can be designed to function as passivation agents on a metal surface by rendering insoluble the metal complex formed from the amidoxime compound or, alternatively, as cleaning agents by increasing the solubility of the metal complex containing residue.

Amidoxime copper complexes have been shown to be readily soluble in water under basic conditions but are less soluble under acidic conditions. Accordingly, the passivating/cleaning duality effect of the amidoxime compound can be controlled by altering the pH.

U.S. Pat. No. 6,166,254, for example, describes the formation of amidoxime compounds from aqueous hydroxylamine free base and nitriles, such as the reaction of acetonitrile with aqueous hydroxylamine at ambient temperature to yield the amidoxime in high purity.

It will be obvious to those of skill in the art that many other nitrites would react with hydroxylamine free base under similar conditions to provide amidoximes.

Amidoximes have been shown to complex with metals, such as copper. For example, amidoximes of cyanoethylated cellulose have been shown to complex with copper and other metal ions. (See, e.g., Altas H. Basta, International Journal of Polymeric Materials, 42, 1-26 (1998)).

An exemplary embodiment of the present invention is compositions, and methods of use thereof, containing a group of higher pH range chelating compounds comprising at least two chelating or complexing compounds where at least one such compound is an amidoxime. The other chelating or complexing compounds may be selected as determined by the objectives of the particular method. Exemplary embodiments of these other chelating or complexing compounds include hydroxamic acid, thiohydroxamic acid, N-hydroxyurea, N-hydroxycarbamate, and N-nitroso-alkyl-hydroxylamine. These compounds offer synergistic advantages when used with amidoximes for the purpose of removing metal oxide residues, such as copper oxide residues, by rendering such oxides soluble in aqueous solutions. As with amidoximes, the chelating or complexing compounds that contain a N-hydroxy functionality can be formed by reaction with hydroxylamine or hydroxylamine derivatives.

Regarding other complexing or chelating agents that may optionally be used with the amidoxime compounds in the compositions of the present application, these agents may be purchased commercially or prepared by known methods.

One particular example of a synergistic functional group is a hydroxamic acid group, which is well known (see, e.g., H. L. Yale, “The Hydroxamic Acids”, Chem. Rev., 209-256 (1943)). Polymers containing hydroxamic acid groups are also known and can be prepared by addition of hydroxylamine to anhydride-containing copolymers, such as styrene-maleic anhydride copolymers or poly(vinylmethylether/maleic anhydride) copolymers, or by reaction of hydroxylamine with ester groups. Polymers containing hydroxamic acid groups can also be prepared by acid-catalyzed hydrolysis of polymers that contain amidoxime groups (see, e.g., U.S. Pat. No. 3,345,344).

U.S. Pat. No. 6,235,935, for example, describes the formation of high purity oximes from aqueous hydroxylamine and ketones reacted at ambient temperature without the presence of impurities such as salts or acids.

Thiohydroxamic acids are an example of a functional group that shows synergy with amidoximes and can be prepared by addition of hydroxylamine to dithiocarboxylic acids (see, e.g., H. L. Yale, Chem. Rev., 33, 209-256 (1943)).

N-hydroxyureas are an example of a functional group that shows synergy with amidoximes and can be prepared by reaction of hydroxylamine with an isocyanate (see, e.g., A. O. Ilvespaa et al., Chimia (Switz.) 18, 1-16 (1964)).

N-Hydroxycarbamates are an example of a functional group that shows synergy with amidoximes and can be prepared by reaction of hydroxylamine with either a linear or cyclic carbonate (see, e.g., A. O. Ilvespaa et al., Chimia (Switz.) 18, 1-16 (1964)).

N-Nitroso-alkyl-hydroxylamines are an example of a functional group that shows synergy with amidoximes and can be prepared by nitrosation of alkyl hydroxylamines (see, e.g., M. Shlino et al., Bioorganic and Medicinal Chemistry 95, 1233-1240 (2001)).

An exemplary embodiment of the present invention involves a cleaning solution which comprises a chelating compound that is an amidoxime (i.e., a compound that contains one or more amidoxime functional groups).

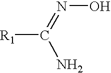

The amidoxime compounds may be prepared by the reaction of nitrile-containing compounds with hydroxylamine.

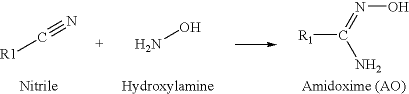

In an exemplary embodiment, the amidoxime chelating compounds are prepared by adding hydroxylamine to the nitrile compound corresponding to the amidoxime. There are several known methods for preparing nitrile compounds, including, but not limited to, cyanide addition reactions such as hydrocyanation, polymerization of nitrile-containing monomers to form polyacrylonitrile or copolymers of acrylonitrile with vinyl monomers, and dehydration of amides. Exemplary procedures for the syntheses of nitrites may be found in J. March, Advanced Organic Chemistry, 4th ed., John Wiley and Sons, NY, (1992).

Nitrile compounds listed in the CRC Handbook (see, e.g., pages 344-368) suitable for use in preparing the amidoxime compounds of this invention include, but are not limited to, the following: Cyanoacetylene, Cyanoacetaldehyde, Acrylonitrile, Fluoroacetonitrile, Acetonitrile (or Cyanomethane), Trichloroacetonitrile, Methacrylonitrile (or α-Methylacrylonitrile), Propionitrile (or Cyanoethane), Isobutyronitrile, Trimethylacetonitrile (or tert-Butylcyanide), 2-Ethyacrylonitrile, Dichloroacetonitrile, α-Chloroisobutyronitrile, n-Butyronitrile (or 1-Cyanopropane), trans-Crotononitrile, Allycyanide, Methoxyacetonitrile, 2-Hydroxyisobutyronitrite (or Acetone cyanohydrins), 3-Hydroxy-4-methoxybenzonitrile, 2-Methylbutyronitrile, Chloroacetonitrile, Isovaleronitrile, 2,4-Pentadienonitrile, 2-Chlorocrotononitrile, Ethoxyacetonitrile, 2-Methycrotononitrile, 2-Bromoisobutyronitrile, 4-Pentenonitrile, Thiophene-2,3-dicarbonitrile (or 2,3-Dicyanothiophene), 3,3-Dimethylaerylonitrile, Valeronitrile (or 1-Cyanobutane), 2-Chlorobutyronitrile, Diethylacetonitrile, 2-Furanecarbonitrite (or α-Furonitrile or 2-Cyanofuran), 2-Methylacetoacetonitrile, Cyclobutanecarbonitrile (or Cyanocyclobutane), 2-Chloro-3-methybutyronitrile, Isocapronitrile (or 4-Methylpentanonitrile), 2,2-Dimethylacetoacetonitrile, 2-Methylhexanonitrile, 3-Methoxypropionitrile, n-Capronitrile (n-Hexanonitrile), (Ethylamino)acetonitrile (or N-Ethylglycinonitrile), d,l-3-Methylhexanonitrile, Chlorofumaronitrile, 2-Acetoxypropionitrile (or O-Acetyllactonitrile), 3-Ethoxypropionitrile, 3-Chlorobutyronitrile, 3-Chloropropionitrile, Indole-3-carbonitrile (or 3-Cyanoindole), 5-Methylhexanonitrile, Thiophene-3-carbonitrile (or 3-Cyanothiophene), d,l-4-Methylhexanonitrile, d,l-Lactonitrile (or Acetaldehydecyanohydrin), Glycoinitrile (or Formaldehydecyanohydrin), Heptanonitrile, 4-Cyanoheptane, Benzonitrile, Thiophene-2-carbonitrile (or 2-Cyanothiophene), 2-Octynonitrile, 4-Chlorobutyronitrile, Methyl cyanoacetate, Dibenzylacetonitrile, 2-Tolunitrile (or 2-Methoxybenzonitrile), 2,3,3-Trimethyl-1-cyclopentene-1-carbonitrile (or □-Campholytonitrile), Caprylonitrile (or Octanonitrile), 1,1-Dicyanopropane (or Ethylmalononitrile), Ethyl cyanoacetate, 1,1-Dicyanobutane (or Propylmalononitrile), 3-Tolunitrile (or 3-Methylbenzonitrile), Cyclohexylacetonitrile, 4,4-Diicyano-1-butene (or Allylmalononitrile), 3-Isopropylidene-1-methyl-cyclopentane-1carbonitrile (or β-Fencholenonitrile), 3-Hydroxypropionitrile, 1,1-Dicyano-3-methylbutane (or Isobutylmalononitrile), Nonanonitrile, 2-Phenytcrotononitrile, Ethylenecyanohydrin, 2-Phenylpropionitrile, Phenylacetonitrile (or Benzylcyanide), Phenoxyacetonitrile, 4-Hydroxy-butyronitrile, (3-Tolyl)acetonitrile (or m-Xylycyanide), (4-Tolyl)acetonitrile (or p-Xylycyanide), 4-Isopropylbenzonitrile, (2-Tolyl)acetonitrile (or o-Xylycyanide), Decanonitrile, 3-Methyl-2-phenylbutyronitrile, 1,2-Dicyanopropane, 1-Undecanonitrile (or 1-Hendecanonitrile), 2-Phenylvaleronitrile, 10-Undecenonitrile (or 10-Hendecenonitrile), 3-Phenylpropionitrile, 2-Cyanobenzalchloride (or α,α-Dichloro-o-tolunitrile), N-Methylanilinonitrile (or N-Cyano-N-methylaniline), 3-(2-Chlorophenyl)propionitrile, 1,3-Dicyano-2-methypropane (or 2-Methylglutaronitrile), O-Benzoyl lactonitrile (or Lactonitrile benzoate), 3-Cyanobenzalchloride (or α,α-Dichloro-m-tolunitrite), 4-Cyanobenzalchloride (or α,α-Dichloro-p-tolunitrile), Dodecanonitrile (or Lauronitrile), 1,3-Dicyanopropane (or Glutaronitrile), 4-Methoxyhydrocinnamonitrile (or 3-(4-Methoxyphenyl)-propionitrile), 1,4-Dicyanobutane (Adiponitrile), 1,2,2,3-Tetramethyl-3-cyclopentene-1-acetonitrile (or 5-Methyl-α-campholenonitrile), 1-Cyanocyclohexene, 2-Hydroxyhutyronitrile (or Propanalcyanohydrin), Hydnocarponitrile, α-Chloro-α-phenylacetonitrile, Butyl cyanoacetate, 3-Bromopropionitrile, 2,4-Diphenylbutyronitrile, Thiophene-2-acetonitrile, Trans-4-Chlrocrotononitrile, 2-Cyanopentanoic acid, Azelaonitrile (or 1,7-Dicyanoheptane), 3-Chloro-2-hydroxy-2-methylpropionitrile (or Chloroacetone cyanohydrins), 1,11-Dicyanoundecane (or 1,11-Dicyanohendecane), 2-Cyanobutyric acid, 2-Cyanobiphenyl, 1,12-Dicyanodedecane (or α,ω-Dodecane dicyanide), 1-Cyano-4-isopropenylcyelohexene, Sebaconitrile (or 1,8-Dicyanooctane), Suberonitrile (or 1,6-Dicyanohexane), 3-Cyanoindene (or Indene-3-carbonitrile), Aminoacetonitrile (or Glycinonitrile), 2-Cyanodiphenylmethane, N-Piperdinoacetonitrile, 3-Chloro-2-tolunitrile, Tetradecanonitrile, Cinnamonitrile, Trichloroacrylonitrile, DL-Mandelonitrile (or Benzaldehyde cyanohydrins), Pentadecanonitrile, 2-Methoxybenzonitrile, (2-Chlorophenyl) acetonitrile (or 2-Chlorobenzylcyanide), 1,1-Dicyanoethane (or Methylmalononitrile), 2-Cyanopyridine (or 2-Pyridinecarbonitrile; Picolinonitrile), 4-tolunitrile (or 4-Methylbenzonitrile), D-Mandelonitrile, d,l-(2-Bromophenyl)acetonitrile (or 2-Bromobenzyl cyanide), (4-Chlorophenyl)acetonitrite (or 4-Chlorobenzyl cyanide), Malononitrile (or Methylene cyanide), Hexadecanonitrile, Maleonitrile (or cis-1,2-Dicyanoethylene), 2,2-Dicyanopropane (or Dimethylmalononitrile), tert-Butylacetonitrile (or Neopentyl cyanide), 1-Naphthylacetonitrile, 4,4-Dicyanoheptane (or Dipropylmalononitrile), Heptadecanonitrile, 1-Naphthonitrile (or 1-Cyanonapthalene), 2-Cyanopropionic acid, 4-Fluorobenzonitrile, Coumarilonitrile (or Coumarin-2-carbonitrile), Indole-3-acetonitrile, 3-Bromobenzonitrile, 2-(N-Anilino)-butyronitrile, Trans-o-Chlorocinnamonitrile, Octadecanonitrile, 3-Chlorobenzonitrile, 2-Chlorobenzonitrile, 4-Chloromandelonitrile, Nonadecanonitrile, 2-Bromo-4-tolunitrile, 3,3-Dicyanopentane (or Diethylmalononitrile), 4-Cyanobutyric acid, 5-Chloro-2-tolunitrile, (4-Aminophenyl)acetonitrile (or 4-Aminobenzyl cyanide), meso-2,3-Dimethyl-succinonitrile, 3-Bromo-4-tolunitrile, (4-Bromophenyl)acetonitrile (or 4-Bromobenzyl cyanide), N-Anilinoacetonitrile, 3-Cyanopropionic acid, 3-Chloro-4-tolunitrile, 3,3-Diphenylacrylonitrile (β-Phenylcinnamonitrile), 3-Bromo-2-hydroxy benzonitrile, 4,4-Dicyanoheptane (or Dipropylmalononitrile), trans-2,3-Diphenyl acrylonitrile, Eicosanonitrile, 3-Cyanopyridine (or Nicotinonitrile), (4-Iodophenyl)acetonitrile (or 4-Iodobenzyl cyanide), 4-Cyanodiphenyl methane, 2-(N-Anilino)valeronitrile, 2-Aminobenzonitrile (or Anthranitonitrile), 2-Bromobenzonitrile, 5-Cyanothiazole, 3-Aminobenzonitrile, 2-Quinolinoacetonitrile, 2-Iodobenzonitrile, 2,4,6-Trimethylbenzonitrile, α-Aminobenzyl cyanide, Cyanoform (or Tricyanomethane), Succinonitrile, 2-Iodo-4-tolunitrile (2-Iodo-4-methylbenzonitrile), 2,6-Dinitrobenzonitril, d,l-2,3-Dimethylsuccinonitrile, 2-Chloro-4-tolunitrile, 4-Methoxybenzonitrile, 2,4-Dichlorobenzonitrile, 4-Methoxycinnamonitrile, 3,5-Dichlorobenzonitrile, cis-1,4-Dicyanocyclohexane, Bromomalononitrile, 2-Naphthonitrile (or 2-Cyanonaphthatene), Cyanoacetic acid, 2-Cyano-2-ethylbutyric acid (or Diethylcyanoacetic acid), 2,4-Diphenylglutaronitrile, α-Chloro-3-tolunitrile, 4-Chloro-2-tolunitrile, 1-Cyanoacenaphthene (or Acenaphthene-1-carbonitrile), Phenylmalononitrile (α-Cyanobenzyl cyanide), 6-Nitro-2-tolunitrile, (4-Hydroxyphenyl)acetonitrile (or 4-Hydroxybenzyl cyanide), bromo-tolunitriles such as 5-Bromo-2-tolunitrile, 2,2-Diphenylglutaronitrile, (2-Aminophenyl)acetonitrile (or 2-Aminobenzyl cyanide); 3,4-Dichlorobenzonitrile, 1,2,2,3-Tetramethylcyclopentene-1-carbonitrile (or Campholic nitrile), Dicyanodimethylamine (or Bis(cyanomethyl)amine), Diphenylacetonitrile (α-Phenylbenzyl cyanide), 4-Cyano-N,N-dimethylaniline, 1-Cyanoisoquinoline, 4-Cyanopyridine, α-Chloro-4-tolunitrile (or 4-Cyanobenzyl chloride), 2,5-Diphenylvaleronitrile, 3-Cyanobenzaldehyde (or 3- Formylbenzonitrile), 6-Nitro-3-tolunitrile, Benzoylacetonitrile, 6-Chloro-2-tolunitrile, 8-Cyanoquinoline, 2-Nitro-3-tolunitrile, 2,3,4,5-Tetrachlorobenzonitrile, 4-Cyanobiphenyl, 2-Naphthylacetonitrile, cis-2,3-Diphenylacrylonitrile, 4-Aminobenzonitrile (or 4-Cyanoaniline), 1-Cyano-2-phenylacrylonitrile (or Benzalmalononitrile), 5-Bromo-2,4-dimethyl-benzonitrile, 2-Cyanotriphenylmethane, 5-Cyanoquinoline, 2,6-Dimethylbenzonitrile, Phenylcyanoacetic acid., 2-(N-Anilino)-propionitrile, 2,4-Dibromobenzonitrile, β-(2-Nitrophenyl)-acrylonitrile, 5-Chloro-2-nitro-4-tolunitrile, α-Bromo-3-tolunitrile (or 3-Cyanobenzyl bromide), 4-Nitro-3-tolunitrile, 2-(N-Anilino)-isobutyronitrile, 2-Cyanoquinoline, 4-Cyanovaleric acid (or 2-Methylglutaromononitrile), Fumaronitrile, 4-Chlorobeuzonitrile, 9-Phenanthrylacetonitrile, 3,5-Dibromobenzonitrile, 2-Chloro-3-nitrobenzonitrile, 2-Hydroxybenzonitrile (or 2-Cyanophenol), 4-Chloro-2-nitrobenzonitrile, 4-Cyanotriphenylmethane, 4-Chloro-3-nitrobenzonitrile, 3-Nitro-4-tolunitrile, 2-Cyano-3-phenylpropionic acid, 3-Cyanophenanthrene, 2,3,3-Triphenylpropionitrile, 4-Cyanoquinoline, 4-Bromo-1-naphthonitrile (or 1-Bromo-4-cyanonaphthalene), 4-Bromo-2,5-dimethylbenzonitrile, 5-Nitro-3-tolunitrile, 2,4-Dinitrobenzonitrile, 4-Nitro-2-tolunitrile, 6-Chloro-3-nitrobenzonitrile, 5-Bromo-3-nitro-2-tolunitrile, 2-Nitro-4-tolunitrile, 9-Cyanophenanthrene, 3-Cyanoquinoline, 2-Cyanophenanthrene, 3-Nitro-2-tolunitrile, 2-Nitrobenzonitrile, 4-Chloro-1-naphthonitrile (or 1-Chloro-4-cyanonaphthalene), 5-Cyanoacenaphthene (or Acenaphthene-5-carbonitrile), 4-Bromobenzonitrile, 2,4,5-Trimethoxybenzonitrile, 4-Hydroxybenzonitrile (or 4-Cyanophenol), 2,3-Diphenylvaleronitrile, α-Bromo-4-tolunitrile (or 4-Cyanobenzylbromide), (4-Nitrophenyl)acetonitrile (or 4-Nitrobenzylcyanide), 6-Bromo-3-nitrobenzonitrile, (2-Hydroxyphenyl)acetonitrile (or 2-Hydroxybenzyl cyanide), 3-Nitrobenzonitrile, 4-Bromo-3-nitrobenzonitrile, 4-Cyanoazobenzene, Dipicolinonitrile (or 2,6-Dicyanopyridine), 2-Cyanohexanoic acid, Dibromomalononitrile (or Bromodicyanomethane), 1-Cyanoanthracene, 2,2,3-Triphenylpropionitrile, 1-Cyanophenanthrene, 2,3-Diphenylbutyronitrile, 5-Bromo-3nitro-4-tolunitrile, 2,5-Dichlorobenzonitrile, 2,5-Dibromobenzonitrile, 5-Bromo-2-nitro-4-tolunitrile, 2-Hydroxy-3-nitrobenzonitrile (or 2-Cyano-6-nitrophenol), 4-Nitro-1-naphthonitrile (or 1-Cyano-4-nitronaphthalene), 4-Acetamidobenzonitrile, 6-Cyanoquinoline, Apiolonitrile (or 2,5-Dimethoxy-3,4-methylenedioxybenzonitrile), 1-Nitro-2-naphthonitrile (or 2-Cyano-1-nitronaphthalene), 3,5-Dichloro-2-hydroxybenzonitrile, trans-1,4-Dicyanocyclohexane, 3,3,3-Triphenylpropionitrile, 4-Cyano-2-phenylquinoline (or 2-Phenyl-4quinolinonitrile), Phthalonitrile (or o-Dicyanobenzene), 8-Nitro-2-naphthonitrile (or 2-Cyano-8-nitronaphthalene), 5-Chloro-2-naphthonitrile (or 5-Chloro-2cyanonaphthalene), 5-Chloro-1-naphthonitrile (or 5-Chloro-1-cyanonaphthalene), 3,5-Dichloro-4-hydroxybenzonitrile, 4-Nitrobenzonitrile, 5-Bromo-1-naphthonitrile (or 1-Bromo-5cyanonaphthalene), 5-Iodo-2-naphthonitrile (or 2-Cyano-5-iodonaphthalene), 3-Cyano-3-phenylpropionic Acid, 2-Cyano-2-propylvaleramide (or Dipropylcyanoacetamide), 2,6-Dibromobenzonitrile, 3-Chloro-4-hydroxybenzonitrile, 5-Chloro-2,4-dinitrobenzonitrile, 4-Benzamidobenzonitrile (or N-Benzoylanthranilonitrile), 5-Bromo-2-hydroxybenzonitrile, d,l-2,3-Diphenylsuccinonitrile, Isophthalonitrile (or m-Dicyanobenzene), 2-Hydroxy-4-nitrobenzonitrile (or 2-Cyano-5-nitrophenol), d,l-4-Cyano-3,4-diphenylbutyric acid (or d,l-2,3-Diphenylglutaromononitrile), d-3-Carboxy-2,2,3-trimethyicyclopentylacetonitrile, 5-Chloro-2-hydroxyhenzonitrile (or 4-Chloro-2-cyanophenol), 2,3-Diphenylcinnamonitrile (or Cyanotriphenylethylene), 1,7-Dicyanonaphthalene, 4,4′-Dicyanodiphenylmethane, 2,2′-Diphenic acid mononitrile (or 2-Carboxy-2′-cyanobiphenyl), 5-Nitro-2-naphthonitrile (or 2-Cyano-5-nitronaphthalene), 9-Cyanoanthracene (or 9-Anthracenecarbonitrile), 2,3-Dicyanopyridine, 1,3-Dicyanonaphthalene, 3-Cyanocoumarin, 2-Cyanocinnamic acid, 2-Cyanobenzoic acid, 1,2-Dicyanonaphthalene, 2-Hydroxy-5-nitrobenzonitrile (or 2-Cyano-4-nitrophenol), Tetracyanoethylene, 5-Nitro-1-naphthonitrile (or 1-Cyano-5-nitronaphthalene), 1,4-Dicyanonaphthalene, 1,6-Dicyanonaphthalene, 1,5-Dicyanonaphthalene, 3-Cyanobenzoic acid, 4-Cyanobenzoic acid, Terephthalonitrile (or p-Dicyanohenzene), 1,8-Dicyanonaphthalene, 4,4′-Dicyanobiphenyl, 1-2,3-Diphenylsuccinonitrile, 1-Cyano-9,10-anthraquinone, 2,3-Dicyanonaphthalene, 2,7-Dicyanonaphthalene, and 2,6-Dicyanonaphthalene.

The present invention further includes the “nitrile quaternaries”, i.e., cationic nitriles containing quaternary ammonium groups of the formula

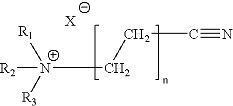

in which R₁ is —H, —CH₃, a C₂₋₂₄-alkyl or a C₂₋₂₄-alkenyl radical, a substituted methyl, substituted C₂₋₂₄-alkyl or substituted C₂₋₂₄-alkenyl radical, wherein the substituted radicals contain at least one substituent from the group —Cl, —Br, —OH, —NH₂, —CN, an alkyl-aryl or alkenyl-aryl radical with a C₁₋₂₄-alkyl group, a substituted alkyl-aryl or substituted alkenyl-aryl radical with a C₁₋₂₄-alkyl group, at least one further substituent on the aromatic ring; R₂ and R₃, independently of one another, are chosen from —CH₂CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH, where n=1, 2, 3, 4, 5 or 6 and X is an anion.

The general formula above covers cationic nitriles which can be used in the present invention. In an exemplary embodiment, the detergent and cleaning compositions according to the invention comprise cationic nitriles in which R₁ is methyl, ethyl, propyl, isopropyl or an n-butyl, n-hexyl, n-octyl, n-decyl, n-dodecyl, n-tetradecyl, nhexadecyl or n-octadecyl radical. In this embodiment, R₂ and R₃ are chosen from methyl, ethyl, propyl, isopropyl and hydroxyethyl, wherein one or both of R₁, R₂ or R₃ may also be a cyanomethylene radical.

In an exemplary embodiment, the radicals R₁, R₂ and R₃ are identical, for example (CH₃)₃N⁽⁺⁾CH₂—CN(X⁻), (CH₃CH₂)₃N⁽⁺⁾CH₂—CN(X⁻), (CH₃CH₂CH₂)₃N⁽⁺⁾CH₂—CN(X⁻), (CH₃CH(CH₃))₃N⁽⁺⁾CH₂—CN(X⁻) or (HO—CH₂—CH₂)₃N⁽⁺⁾CH₂—CN(X⁻), where in this embodiment, X⁻ is an anion chosen from the group consisting of hydroxide, chloride, bromide, iodide, hydrogen sulfate, methylsulfonate(mesylate), p-toluenesulfonate(tosylate) or xylenesulfonate.

Representative examples of typical acrylonitrile polymers, which serve as precursors for preparing polyamidoximes, are listed below. The figures are the percents by weight of each monomer in the polymer.

| | | |
|---|---|---|
| 90% acrylonitriIe | 10% vinylacetonitrile | |
| 50%′ acrylonitrile | 50% methacrylonitrile | |
| 97% acrylonitrile | 3% vinyl acetate | |
| 50% acrylonitrile | 50% vinyl acetate | |
| 95% acrylonitrile | 5% methyl methacrylate | |
| 65% acrylonitrile | 35% methyl acrylate | |
| 45% acrylonitrile | 10% methyl acrylate | 45% vinyl acetate |
| 44% acrylonitrile | 44% vinyl chloride | 12% methyl acrylate |
| 93% acrylonitrile | 7% 2-vinyl pyridine | |
| 26% acrylonitrile | 74% butadiene | |
| 40% 1 acrylonitrile | 60% butadiene | |
| 33% acrylonitrile | 67% styrene | |
| 100% acrylonitrile | | |

A representative sample of commercially available nitrile-containing polymers is shown below.

| Product | Manufacturer | Composition |
|---|---|---|
| Orion | DuPont de Nemours | 90% Acrylonitriles |
| Acrilan | Chemstrand | 90% AcryIonitriles |
| Creslan | American Cyanamid | 95-96% Acrylonitriles |
| Zefran | Dow Chemical Co., | 90% Acrylonitriles |
| Verel | Eastman | About 50% acryIonitrile |
| Dyrel | Carbide &Carbon | 40% acrylonitrile-60% Vinyl |
| | Chemical | chloride |
| Darlan | B. F Goodrich | 50 Mole percent vinylidene cyanide- |
| | | 50 Mole percent Vinyl acetate |

In a particular embodiment, the route used to obtain nitriles is termed “cyanoethylation”, in which acrylonitrile, which is optionally substituted, undergoes a conjugate addition reaction with protic nucleophiles such as alcohols and amines. Other unsaturated nitrites can also be used in place of acrylonitrile.

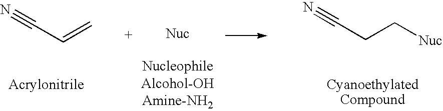

Exemplary amines for the cyanoethylation reaction are primary amines and secondary amines having 1 to 30 carbon atoms, and polyethylene amine. Alcohols may be primary, secondary, or tertiary. The cyanoethylation reaction (or “cyanoalkylation” reaction) using an unsaturated nitrile other than acrylonitrile may be carried out in the presence of a cyanoethylation catalyst. In an exemplary embodiment, the cyanoethylation catalysts include lithium hydroxide; sodium hydroxide; potassium hydroxide; and metal ion free bases from tetraalkylammonium hydroxide, such as tetramethylammonium hydroxide (TMAH), TMAH pentahydrate, BTMAH (benzyltetramethylammonium hydroxide), tetrabutylammonium hydroxide (TBAH), choline, and TEMAH (Tris(2-hydroxyethyl)methylammonium hydroxide). In an exemplary embodiment, the amount of catalyst used is between 0.05 mol % and 15 mol %, based on unsaturated nitrile.

In an exemplary embodiment, the cyanoethylation products are derived from the following groups:

from arabitol, erythritol, glycerol, isomalt, lactitol, maltitol, mannitol, sorbitol, xylitol, sucrose and hydrogenated starch hydrosylate (HSH);

from hydroxy acids: hydroxyphenylacetic acid (mandelic acid), 2-hydroxypropionic acid (lactic acid), glycolic acid, hydroxysuccinic acid (malic acid), 2,3-dihydroxybutanedioic, acid (tartaric acid), 2-hydroxy-1,2,3-propanetricarboxylic, acid (citric acid), ascorbic acid, 2-hydroxybenzoic, acid (salicylic acid), 3,4,5-trihydroxybenzoic acid (gallic acid);

from sugar acids: galactonic acid, mannonic, acid, fructonic acid, arabinonic acid, xylonic acid, ribonic, acid, 2-deoxyribonic acid, and alginic acid;

from amino acids: alanine, vatine, leucine, isoleucine, proline, tryptophan, phenylalanine, methionine, glycine, serine, tyrosine, threonine, cysteine, asparagine, glutamine, aspartic acid, glutamic acid, lysine, arginine, and histidine;

from monomeric polyols- or polyhydric alcohols, or glycol ethers, chosen from ethanol, n-propanol, isopropanol, butanols, glycol, propane- or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy, ethoxy or butoxy triglycol, 1-butoxyethoxy-2-propanol, 3-methyl-3-methoxybutanol, propylene glycol t-butyl ether, and pentaerythritol;

from polymeric polyols, chosen from the group of polyethylene glycols and polypropylene glycols, wherein the polyethylene glycols (PEGS) are polymers of ethylene glycol which satisfy the general formula

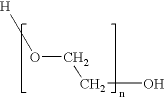

where n can assume values between 1 (ethylene glycol, see below) and about 16. A number of polyethylene glycols are commercially available, for example, under the trade names Carbowax®, PEG 200 (Union Carbide), Emkapol® 200 (ICI Americas), Lipoxol® 200 MED (HOLS America), Polyglycol® E-200 (Dow Chemical), Alkapol® PEG 300 (Rhone-Poulene), Lutrol® E300 (BASF), and the corresponding trade names with higher numbers. Polypropylene glycols (PPGs) which can be used according to the invention are polymers of propylene glycol which satisfy the general formula

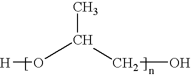

where n can assume values between 1 (propylene glycol) and about 12. In an exemplary embodiment, the polypropylene glycols are di-, tri- and tetrapropylene glycol, i.e., the representatives where n=2, 3 and 4 in the above formula;

from organic nitrogen compounds, wherein these compounds include the classes of amines, amides and imides as described below in greater detail:

amines: structurally, amines resemble the compound ammonia (NH₃), wherein one or more hydrogen atoms are replaced by organic substituents such as alkyl, heteralkyl, aryl and heteroaryl groups. Compounds containing one or more —NH— groups of the formula, wherein R₁, R₂ and R₃ are as described above for the nitrile quaternaries:

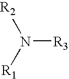

amides: an amide may be regarded as an amine where one of the nitrogen substituents is an acyl group; it is generally represented by the formula. R₁(CO)NR₂R₃, where either or both R₂ and R₃ may be hydrogen and R₁ is as described above for the nitrile quaternaries. Specifically, an amide can also be regarded as a derivative of a carboxylic acid in which the hydroxyl group has been replaced by an amine or ammonia.

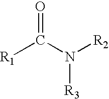

imide: an imide is a functional group consisting of two carbonyl groups bound to an amine. In an exemplary embodiment, R₃ is H in the generic structure for the imide shown below and R₂ and R₃ are independently alkyl, heteroalkyl, aryl or heteroaryl;

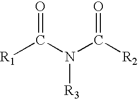

from amino alcohols (or alkanolamines) wherein the amino alcohols are organic compounds that contain both an amine functional group and an alcohol functional group, and where the amine can be a primary or secondary amine of the formula, wherein X is independently selected from alkylene, heteroalkylene, arylene, heteroarylene, alkylene-heteroaryl, or alkylene-aryl group.

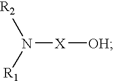

from synthetic polymers, wherein the synthetic polymers include, but are not limited to, acetone-formaldehyde condensate, acetone-isobutyraldehyde condensate, methyl ethyl ketone-formaldehyde condensate, poly(allyl alcohol), poly(crotyl alcohol), poly(3-chloroallyl alcohol), ethylene-carbon monoxide copolymers, polyketone from propylene, ethylene and carbon monoxide, poly(methallyl alcohol, poly(methyl vinyl ketone, and poly(vinyl alcohol).

Synthetic polymers such as acetone-formaldehyde condensate, acetone-isobutyraldehyde condensate, methyl ethyl ketone-formaldehyde condensate, poly(allyl alcohol), poly(crotyl alcohol), poly(3-chloroallyl alcohol), ethylene-carbon monoxide copolymers, polyketone from propylene, ethylene and carbon monoxide, poly(methallyl alcohol, poly(methyl vinyl ketone, and poly(vinyl alcohol) have also been cyanoethylated and can also serve as platforms for further modification into metal-binding polymers.

The nitrile groups of these cyanoethylates or cyanoalkylates can be reacted with hydroxylamine to form the amidoxime. In the process described herein for preparing amidoxime groups, hydroxylamine and hydroxylamine salts such as hydroxylamine hydrochloride, and hydroxylamine sulfate are suitable sources of hydroxylamine. If a hydroxylamine salt is used instead of hydroxylamine free base, a metal ion base such as, for example, sodium hydroxide, sodium carbonate or a metal ion-free base such as, for example, ammonium hydroxide or tetraalkylammonium hydroxide, should be used to convert hydroxylamine to the free base for the reaction.

In a particular embodiment, the metal-ion-free base, is ammonium hydroxide or a group of a tetraalkylammonium hydroxide, such as tetramethylammonium hydroxide (TMAH), TMAH pentahydrate, BTMAH (benzyltetramethylammonium hydroxide), tetrabutylammonium hydroxide (TBAH), choline, or TEMAH (Tris(2-hydroxyethyl)methylammonium hydroxide).

Metals, such as, for example, copper, complex strongly with molecules containing an amidoxime functionality. In a particular embodiment, amidoximes of sucrose and sorbitol bind metal contaminant residues.

The present invention offers the benefit of binding to the metal oxide surface to create an oxidation barrier, particularly where the amidoxime is derived from functionalized amidoxime polymer, such as from polyvinylalcohol, polyacrylonitriles and its copolymers.

The present invention utilizes the cyanoethylated compounds referenced in “The Chemistry of Acrylonitrile”, 2nd ed. as starting materials for synthesis of amidoximes, and this reference is incorporated herein to the extent of the cyanoethylated compounds disclosed therein. In an exemplary embodiment, the starting materials for synthesis of amidoximes are those prepared from cyanoethylated sugar alcohols, such as sucrose, or reduced sugar alcohols, such as sorbitol.

The present invention further offers the benefit of increasing the bulk removal of metal during the CMP process when a chelating agent disclosed herein (e.g., (1,2,3,4,5,6-(hexa-(2-amidoximo)ethoxy)hexane) combined with a compound with oxidation and reduction potentials such as hydroxylamine and its salts, hydrogen peroxide, hydrazines.

Because the chelating agents disclosed herein are not carboxylic acid based but are instead contain multiple ligand sites, the present invention further offers the benefit of more efficient and effective binding to metal ions found in semiconductor manufacturing processes, such as residues after plasma etching, particularly with leading edge technology where copper is used as a conducting metal.

Another advantage of the chelating agents disclosed herein is that such chelating agents could be used in dilution as a post-copper CMP clean because these groups of compounds are less acidic than organic acids and less basic than ammonia, choline hydroxide and THEMAH. In an exemplary embodiment, the compositions comprising an amidoxime compound are further diluted with water prior to removing residue from a substrate, such as during integrated circuit fabrication. In a particular embodiment, the dilution factor is from about 10 to about 500.

### General Procedures on Preparation of Amidoxime

### Examples of Cyanoethylation to Produce Nitrile Compounds

### Preparation of β-Ethoxypropionitrile, C₂H₅—O—CH₂—CH₂CN

Placed 25 ml of 2 percent aqueous sodium hydroxide and 26 g. (33 ml.) of ethyl alcohol in a 250 ml. reagent bottle, add 26·5 g. (33 ml.) of acrylonitrile and closed the mouth of the bottle with a tightly-fitting cork. Agitated the resulting clear homogeneous liquid in a shaking machine for 2 hours. During the first 15 minutes the temperature of the mixture increased 15° C. to 20° C. and thereafter decreased gradually to room temperature; two liquid layers separated after about 10 minutes. Removed the upper layer and added small quantities of 5 percent acetic acid to it until neutral to litmus; discarded the lower aqueous layer. Dried with anhydrous magnesium sulfate, distilled and collected the β-Ethoxypropionitrile at 172-174° C. The yield was 32 g.

### β-n-Propoxypropionitrile, C₃H₇—O—CH₂—CH₂—CN

Introduced 0.15 g of potassium hydroxide and 33 g. (41 ml) of dry n-propyl alcohol into a 150 ml. bolt-head flask, warmed gently until the solid dissolved, and then cooled to room temperature. Clamped the neck of the flask and equipped it with a dropping funnel, a mechanical stirrer and a thermometer (suitably supported in clamps). Introduced from the dropping funnel, with stirring, 26.5 g. (33 ml) of pure acrylonitrile over a period of 2.5-30 minutes (1 drop every ca. 2 seconds). Did not allow the temperature of the mixture to rise above 35-45° C.; immersed the reaction flask in a cold water bath, when necessary. When all the acrylonitrile had been added, heated under reflux in a boiling water bath for 1 hour; the mixture darkened. Cooled, filtered and distilled. Collected the β-n-Propoxypropionitrile at 187-189° C. The celd was 38 g.

### β-Diethylaminopropionitrile, (C₂H₅)₂N—CH₂—CH₂—CN

Mixed 42.5 g (60 ml) of freshly-distilled diethylamine and 26.5 g. (33 ml) of pure acrylonitrile in a 250 ml round-bottomed flask fitted with a reflux condenser. Heated at 50° C. in a water bath for 10 hours and then allowed to stand at room temperature for 2 days. Distilled off the excess of diethylamine on a water bath, and distilled the residue from a Claisen flask under reduced pressure. Collected the β-Diethylaminopropionitrile at 75-77° C./11 mm. The yield was 54 g.

### β-Di-n-butylaminopropionitrile, (C₄H₉)₂N—CH₂—CH₂—CN

Proceeded as for the diethyl compound using 64.5 g. (85 ml) of redistilled di-n-butylamine and 26.5 g. (33 ml.) of pure acrylonitrile. After heating at 50° C. and standing for 2 days, distilled the entire product under diminished pressure (air bath); discarded the low boiling point fraction containing unchanged di-n-butylamine and collected the β-Di-n-butylaminopropionitrile at 120-122° C./ 110 mm. The yield was 55 g.

### Ethyl n-propyl-2-cyanoethylmalonate

Added 8.0 g (10.0 ml) of redistilled acrylonitrile to a stirred solution of ethyl n-propyl malonate (30.2 g.) and of 30 percent methanolic potassium hydroxide (4.0 g.) in tert-butyl alcohol (100 g.). Kept the reaction mixture at 30°-35° C. during the addition and stirred for a further 3 hours. Neutralized the solution with dilute hydrochloric acid (1:4), diluted with water and extracted with ether. Dried the ethereal extract with anhydrous magnesium sulfate and distilled off the ether, the residue (ethyl n-propyl-2-cyanoethylmalonate; 11 g) solidified on cooling in ice, and melted at 31°-32° C. after recrystallization from ice-cold ethyl alcohol.

### Preparation of Cyanoethylated Compound

A cyanoethylated diaminocyclohexane was prepared according to U.S. Pat. No. 6,245,932, which is incorporated herein by reference, with cyanoethylated methylcyclohexylamines, which are readily prepared in the presence of water.

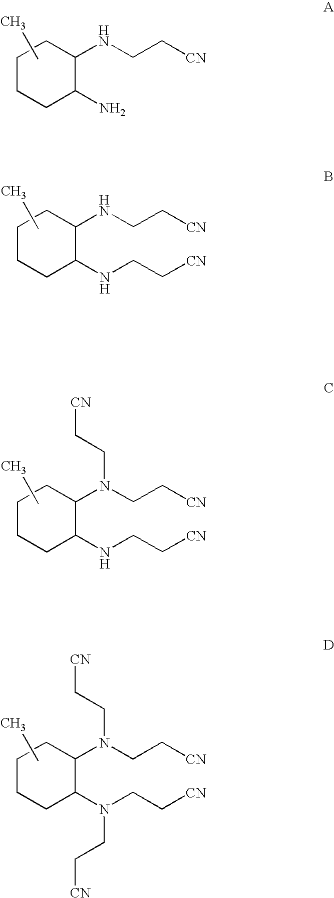

Analysis showed that almost no compounds represented by structures C and D were produced when water alone is used as the catalytic promoter.

Examples of reaction of nitrile compounds with hydroxylamine to form amidoxime compounds:

### Preparation and Analysis of Polyamidoximes (See, e.g., U.S. Pat. No. 3,345,344)

80 parts by weight of polyacrylonitrile of molecular weight of about 130,000 in the form of very fine powder (−300 mesh) was suspended in a solution of 300 parts by weight of hydroxylammonium sulfate, 140 parts by weight of sodium hydroxide and 2500 parts by weight of deionized water. The pH of the solution was 7.6. The mixture was heated to 90° C. and held at that temperature for 12 hours, all of the time under vigorous agitation. It was cooled to 35° C. and the product filtered off and washed repeatedly with deionized water. The resin remained insoluble throughout the reaction, but was softened somewhat by the chemical and heat. This caused it to grow from a very fine powder to small clusters of 10 to 20 mesh. The product weighed 130 grams. The yield 40 is always considerably more than theoretical because of firmly occluded salt. The product is essentially a polyamidoxime having the following reoccurring unit.

The mixture of hydroxylamine sulfate and sodium hydroxide can be replaced with equal molar of hydroxylamine freebase solution.

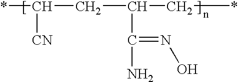

Portions of this product were then analyzed for total nitrogen and for oxime nitrogen by the well-known Dumas and Raschig methods and the following was found.

| | Percent |
|---|---|
| Total nitrogen (Dumas method) | 22.1 |
| Oxime nitrogen (Raschig method) | 6.95 |
| Amidoxime nitrogen (twice the amount of | 13.9 |
| oxime nitrogen) (calculated) | |
| Nitrile nitrogen (difference between the total | 8.2 |
| nitrogen and amidoxime nitrogen) (calculated) | |

### Conversion of Reacted Product from Cyanoethylation of Cycloaliphatic Vicinal Primary Amines (See, e.g., U. S. Pat. No. 6,245,932)

For example, cyanoethylated methylcyclohexylamines:

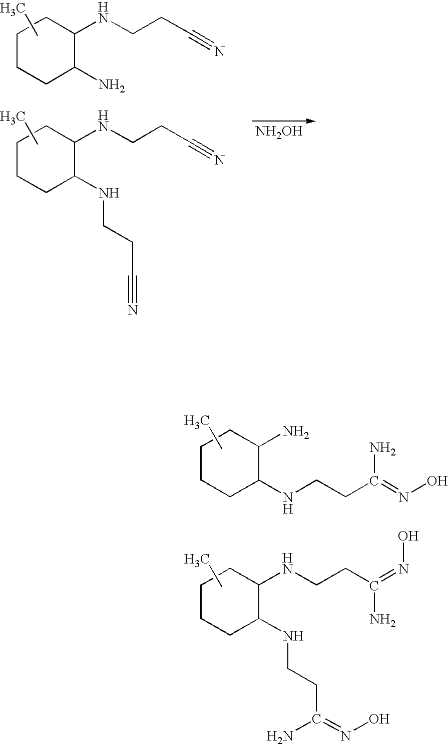

A large number of the amidoxime compounds are not commercially available. In an exemplary embodiment, these amidoxime compounds, as well as those commercially available, are prepared in-situ, particularly from nitrile compounds and hydroxylamine, while blending the cleaning formulations of the invention.

The following are exemplary photoresist stripper formulations that may be used with the amidoximes compounds of the present invention:

| | | | | | | After | | After | | | | Stripper |
|---|---|---|---|---|---|---|---|---|---|---|---|---|
| | | | | Start | | Step 1 | | Step 2 | | End | | Com- |
| | | Ingredient | MW | mole | Wt | mole | Wt | mole | Wt | mole | Wt | position |
| Step 1 | Amine | 2-Pyrolidone | 85.11 | 1.00 | 85.11 | 0.00 | 0.00 | 0.00 | 0.00 | 0.00 | 0.00 | 0% |
| | Nitrile | Acrylonitrile | 53.00 | 1.00 | 53.00 | 0.00 | 0.00 | 0.00 | 0.00 | 0.00 | 0.00 | 0% |
| | Metal Ion | TMAH | 91.00 | 0.05 | 4.55 | 0.05 | 4.53 | 0.05 | 4.55 | 0.05 | 4.55 | 2% |
| | free base | | | | | | | | | | | |
| | | Water | 18.00 | 0.76 | 13.65 | 0.76 | 13.65 | 0.76 | 13.70 | 0.76 | 13.68 | 6% |
| | Cyanoethylated | | 137.10 | 0.00 | 0.00 | 1.00 | 137.10 | 0.00 | 0.00 | 0.00 | 0.00 | 0% |
| | Compound | | | | | | | | | | | |
| Step 2 | Oxidizing/ | Hydroxylamine | 31.00 | 1.00 | 31.00 | 0.00 | 0.00 | 0.00 | 0.00 | 0.00 | 0.00 | 0% |
| | Reducing | | | | | | | | | | | |
| | compound | | | | | | | | | | | |
| | Water | Water | 18.00 | 1.72 | 31.00 | 0.00 | 0.00 | 1.72 | 31.00 | 1.72 | 31.00 | 14% |
| | Amidoxime | Amidoxime | 170.00 | 0.00 | 0.00 | 0.00 | 0.00 | 1.00 | 170.00 | 1.00 | 170.00 | 78% |

| | | |
|---|---|---|
| 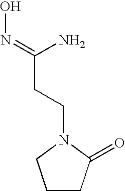 | 219.20 | 100% |

| | Ingredient | Stripper Composition |
|---|---|---|
| Metal Ion free base | TMAH | 2% |
| Water | Water | 20% |
| Amidoxime | 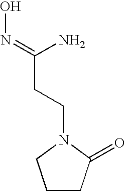 | 78%100% |

### Exemplary Amidoximes Prepared from Amines

| 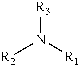 | | | 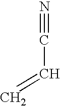 | 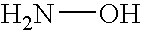 |
|---|---|---|---|---|
| R1 | R2 | R3 | Nitrile | Amidoxime |
| —H | —H | —H | 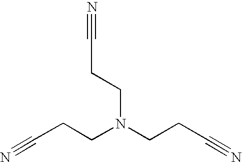 1:3 | 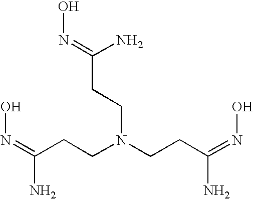 1:3:3 |
| CH3CH2 | H | H | 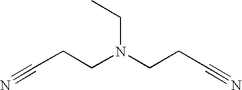 1:2 | 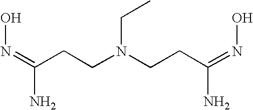 1:2:2 |
| CH3CH2 | CH3CH2 | H | 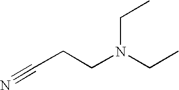 1:1 | 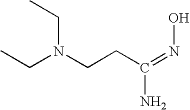 1:1:1 |

### Exemplary Amidoximes Prepared from Citric Acid

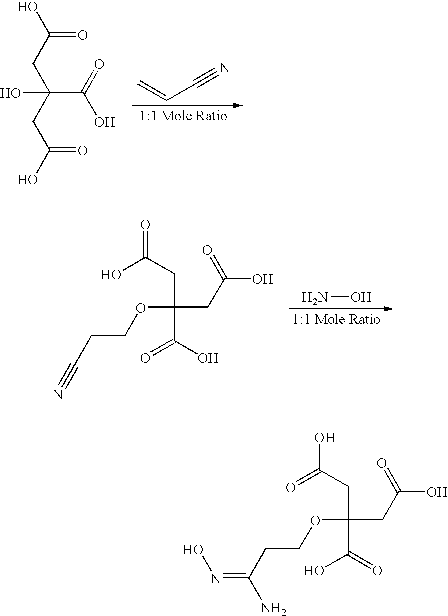

| Reactants | 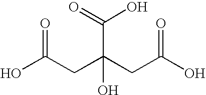 |
|---|---|
| CA:AN:HA 1:1:1 | 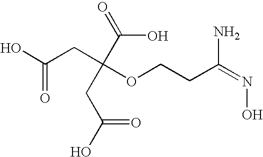 |
| CA:AN:HA 1:1:1 | 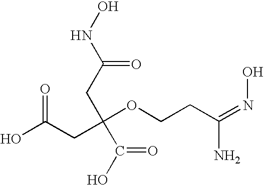 |
| CA:AN:HA 1:1:1 | 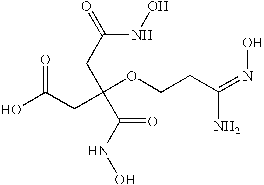 |
| CA:AN:HA 1:1:1 | 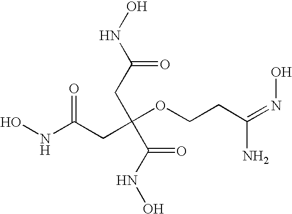 |

### Exemplary Amidoximes Prepared from Lactic Acid

| 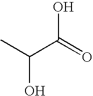 Lactic Acid | 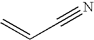 | Amidoxime Compounds | |
|---|---|---|---|
| — | 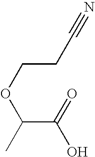 | 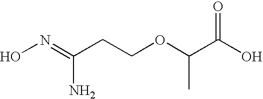 1:1:1 | 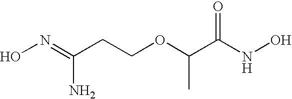 1:1:2 |

### Exemplary Amidoximes Prepared from Propylene Glycol

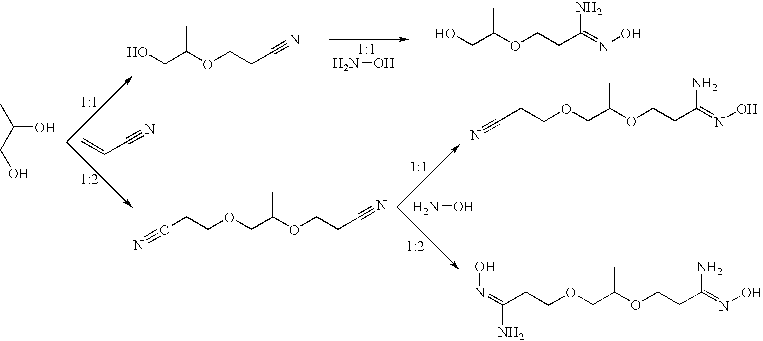

| | Amidoxime Compounds | | |
|---|---|---|---|
| Reactant | PG:AN:HA 1:1:1 | PG:AN:HA 1:2:1 | PG:AN:HA 1:2:2 |
| 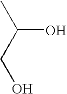 | 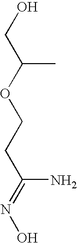 | 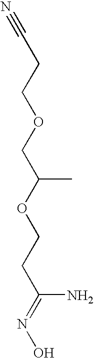 | 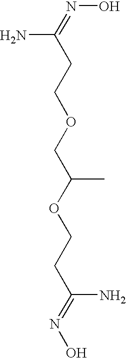 |

### Exemplary Amidoximes Prepared from Pentaerythritol—DS1

| | | | |
|---|---|---|---|
| 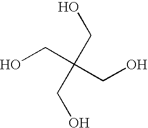 | 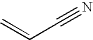 | H₂N—OH | Amidoxime Compounds |

| | | |
|---|---|---|
| 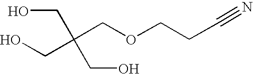 1:1 | 1 | 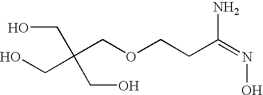 |

### Exemplary Amidoximes Prepared from Pentaerythritol—DS2

| | | | |
|---|---|---|---|
| 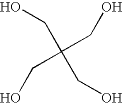 | 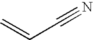 | H₂N—OH | Amidoxime Compounds |

| | | |
|---|---|---|
| 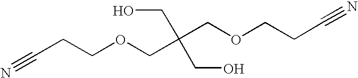 1:2 | 1 | 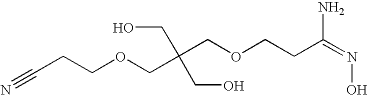 |
| | 2 | 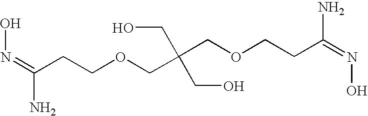 |

### Exemplary Amidoximes Prepared from Pentaerythritol—DS3

| | | | |
|---|---|---|---|
| 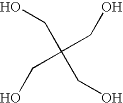 | 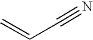 | H₂N—OH | Amidoxime Compounds |

| | | |
|---|---|---|
| 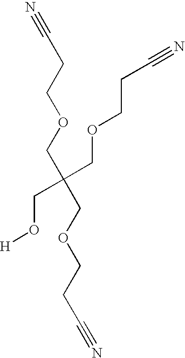 | 1 2 | 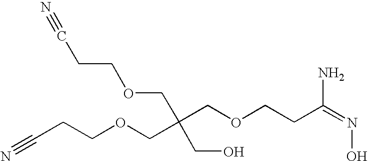 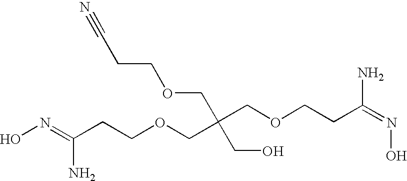 |
| 1:3 | 3 | 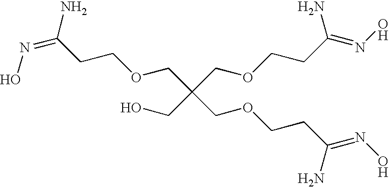 |

### Exemplary Amidoximes Prepared from Pentaerythritol—DS4

| | | | |
|---|---|---|---|
| 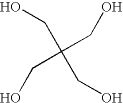 | 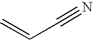 | H₂N—OH | Amidoxime Compounds |

| | | |
|---|---|---|
| 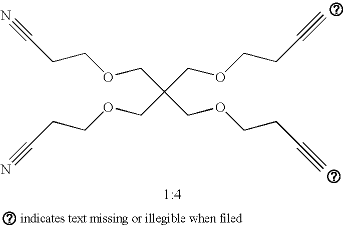 | 1 | 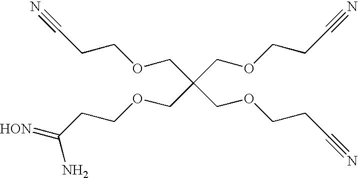 |
| | 2 | 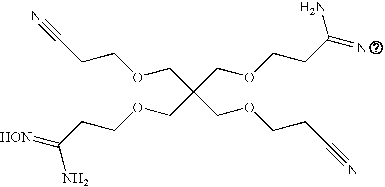 |
| | 3 | 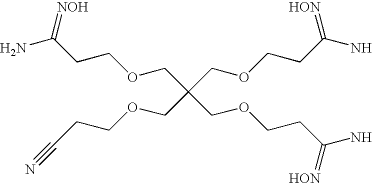 |
| | 4 | 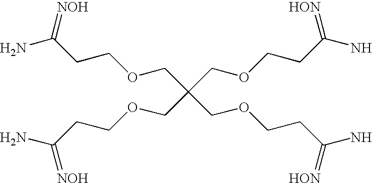 |

### α-Substituted Acetic Acids

| | |
|---|---|
| R | 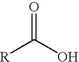 |

| | |
|---|---|
| —CH₃ | Acetic Acid |
| —CH₂OH | Glycolic Acid |
| —CH₂NH₂ | Glycine |
| —CHO | Glyoxylic Acid |

| 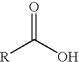 | | H₂N—OH | | |
|---|---|---|---|---|
| R | 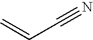 | 1 | 2 | 3 |
| —CH₃ | | 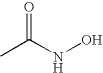 | | |
| —CH₂OH | 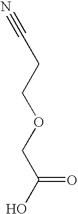 | 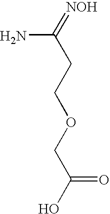 | 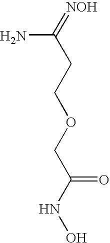 | |
| —CH₂NH₂ | 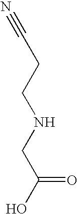 | 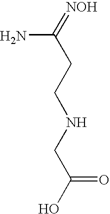 | 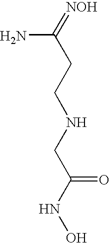 | |
| —CH₂NH₂ | 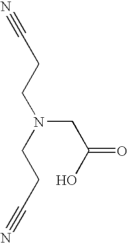 | 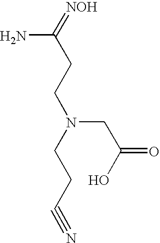 | 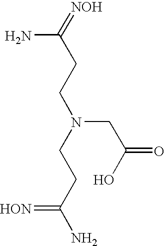 | 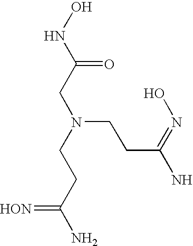 |
| —CHO | 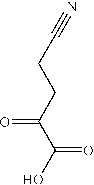 | 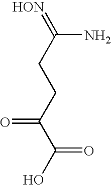 | 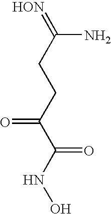 | |

### Exemplary Amidoximes Prepared from Iminodiacetic Acid

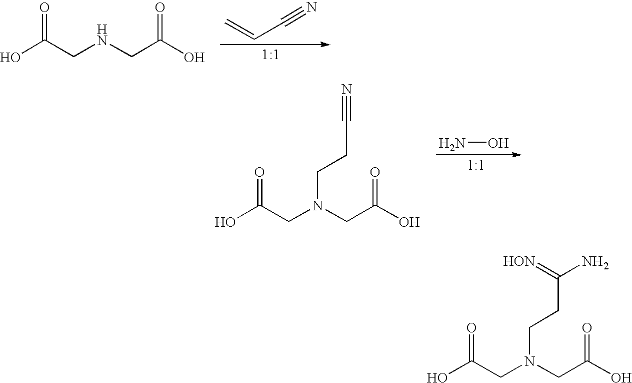

| Reactants | 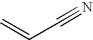 | H₂N—OH | 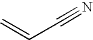 | H₂N—OH | 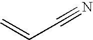 | H₂N—OH |
|---|---|---|---|---|---|---|
| 1 | 1 | 1 | 1 | 2 | 1 | 3 |

| | | | |
|---|---|---|---|
| 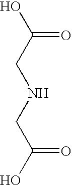 | 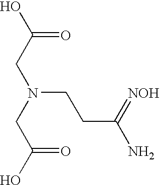 | 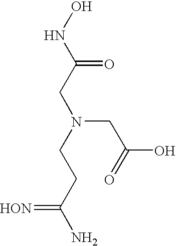 | 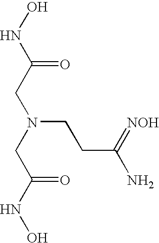 |

### Exemplary Amidoximes Prepared from 2,5-piperazinedione

| Reactants | 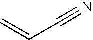 | H₂N—OH | 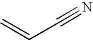 | H₂N—OH | 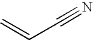 | H₂N—OH |
|---|---|---|---|---|---|---|
| 1 | 1 | 1 | 2 | 1 | 2 | 2 |

| | | | |
|---|---|---|---|
| 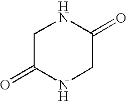 | 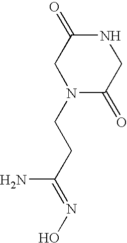 | 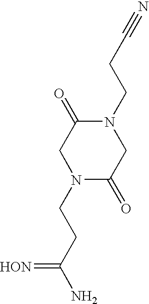 | 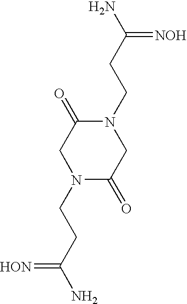 |

### Exemplary Amidoximes Prepared from Cyanopyridine

| Reactants | H₂N—OH | 1594-57-6 |
|---|---|---|
| 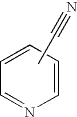 | 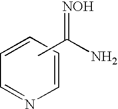 | 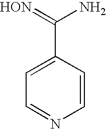 |
| 2, 3 or 4 Cyanopyridine | 2, 3 or 4 Amidoxime | 4-Amidoxime-pyridine |
| | pyridine | |

### Cyanoethylation of Sorbitol to Produce Multi Substituted-(2-amidoximo)ethoxy)hexane

1. A one-liter three-necked round-bottomed flask was equipped with a mechanical stirrer, reflux condenser, thermometer, and 100 ml addition funnel under nitrogen. Lithium hydroxide monohydrate (1.0 g, 23.8 mmol, 0.036 eq) dissolved in water (18.5 ml) was added to the flask, followed by the addition of sorbitol (120 g, 659 mmol) in one portion, and then water (100 ml). The solution was warmed to 42° C. in a water bath and treated with acrylonitrile (43.6 ml, 659 mmol, and 1.0 eq) dropwise via the addition funnel for a period of 2 hr, while maintaining the temperature at 42° C. After the addition was complete, the solution was warmed to 50-55° C. for 4 hr and then allowed to cool to room temperature. The reaction was neutralized by addition of acetic acid (2.5 ml) and allowed to stand overnight at room temperature. The solution was evaporated under reduced pressure to give the product as a clear, viscous oil (155.4 g).

In the above described experimental procedure, tetramethylammonium hydroxide may be used as a substitute for lithium hydroxide.

Elemental analysis: Found, 40.95% C; 3.85% N. The IR spectrum showed a peak at 2255 cm⁻¹ indicative of a nitrile group.

2. A one liter three-neck round-bottomed flask was equipped with a mechanical stirrer, reflux condenser, thermometer, and 100 ml addition funnel under nitrogen. Lithium hydroxide (1.0 g, 23.8 mmol, 0.036 eq) dissolved in water (18.5 ml) was added to the flask, followed by the addition of the first portion of sorbitol (60.0 g, 329 mmol) and then water (50 ml). The solution was warmed to 42° C. in a water bath and treated with acrylonitrile (42 ml, 633 mmol, 0.96 eq) dropwise via the addition funnel for a period of 1 hr while maintaining the temperature at 42° C. The second portion of sorbitol (60 g, 329 mmol) and water (50 ml) were added to the flask. The second portion of the acrylonitrile (89.1 ml, 1.344 mol, 2.04 eq) was added in a dropwise fashion over a period of 1 hr. After the addition was complete, the solution was warmed to 50-55° C. for 4 hr and then allowed to cool to room temperature. The reaction was neutralized by addition of acetic acid (2.5 ml) and allowed to stand overnight at room temperature. The solution was evaporated under reduced pressure to give the product as a clear, viscous oil (228.23 g).

In the above described experimental procedure, tetramethylammonium hydroxide may be used as a substitute for lithium hydroxide.

Elemental analysis: Found: 49.16% C; 10.76% N. The IR spectrum showed a peak at 2252 cm⁻¹ indicative of a nitrile group.

3. A 1000 ml 3-necked round-bottomed flask equipped with a mechanical stirrer, reflux condenser, nitrogen purge, dropping funnel, and thermometer was charged with water (18.5 ml) and lithium hydroxide monohydrate (1.75 g) and the first portion of sorbitol (44.8 g). The solution was heated to 42° C. with a water bath with stirring and the second portion of sorbitol (39.2 g) was added directly to the reaction flask. The first portion of acrylonitrile (100 ml) was then added to the reaction drop-wise via a 500 ml addition funnel over a period of 2 hr. The reaction was slightly exothermic, raising the temperature to 51° C. The final portion of sorbitol (32 g) was added for a total of 0.638 moles followed by a final portion of acrylonitrile (190 ml) over 2.5 hr keeping the reaction temperature below 60° C. (A total of 4.41 moles of acrylonitrile was used.) The reaction solution was then heated to 50-55° C. for 4 hr. The solution was then allowed to cool to room temperature and the reaction was neutralized by addition of acetic acid (2.5 ml). Removal of the solvent under reduced pressure gave the product as a clear, viscous oil (324 g).

In the above described experimental procedure, tetramethylammonium hydroxide may be used as a substitute for lithium hydroxide.

The IR spectrum showed a peak at 2251 cm⁻¹, indicative of a nitrile group.

4. Preparation of (1,2,3,4,5,6-(hexa-(2-amidoximo)ethoxy)hexane.

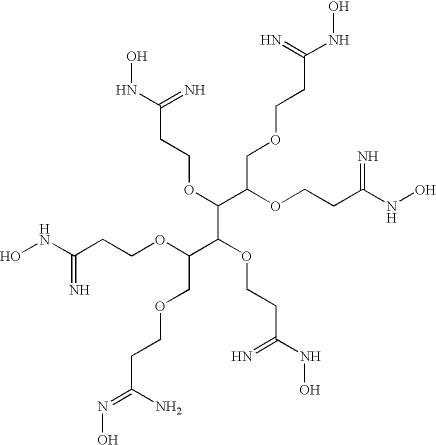

A 1000 mL three-necked round-bottomed flask was equipped with a mechanical stirrer, condenser, and addition funnel under nitrogen. CE-Sorb6 (14.77 g, 29.5 mmol) and water (100 mL) were added to the flask and stirred. In a separate 500 mL Erlenmeyer flask, hydroxylamine hydrochloride (11.47 g, 165 mmol, 5.6 eq) was dissolved in water (178 mL) and then treated with ammonium hydroxide (22.1 mL of 28% solution, 177 mmol, 6.0 eq) for a total volume of 200 mL. The hydroxylamine solution was then added in one portion directly to the mixture in the round-bottomed flask at room temperature. The stirred mixture was heated at 80° C. for 2 hr, pH=8-9, and then allowed to cool to room temperature.

Hydroxylamine free base (50%, aqueous solution) can be used to replace the solution by blending hydroxylamine chloride and ammonium hydroxide.

The IR spectrum indicated loss of most of the nitrile peak at 2250 cm⁻¹ and the appearance of a new peak at 1660 cm⁻¹, indicative of the amidoxime or hydroxamic acid.

The preparation and analysis of polyamidoximes is essentially that described in U.S. Pat. No. 3,345,344, which is incorporated herein by reference in its entirety. In that process, 80 parts by weight of polyacrylonitrile of molecular weight of about 130,000 in the form of a very fine powder (−300 mesh) was suspended in a solution of 300 parts by weight of hydroxylammonium sulfate, 140 parts by weight of sodium hydroxide and 2500 parts by weight of deionized water. The pH of the solution was 7.6. The mixture was heated to 90° C. and held at that temperature for 12 hours, all of the time under vigorous agitation. It was cooled to 35° C. and the product filtered off and washed repeatedly with deionized water. The resin remained insoluble throughout the reaction, but was softened somewhat by the chemical and heat. This caused it to grow from a very fine powder to small clusters of 10 to 20 mesh. The product weighed 130 grams. The yield is always considerably more than theoretical because of fumly occluded salt. The product is essentially a poly-amidoxime having the following reoccurring unit

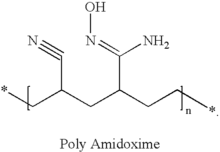

The following depicts metal complexing using amidoxime compounds.

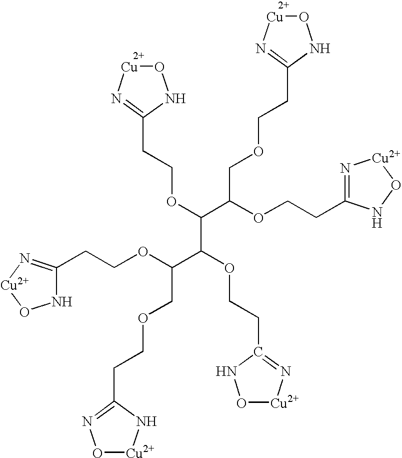

Amidoxime chelating agents may be substituted for organic carboxylic acids, organic carboxylic ammonium salts or amine carboxylates for use in cleaning formulations and processes.

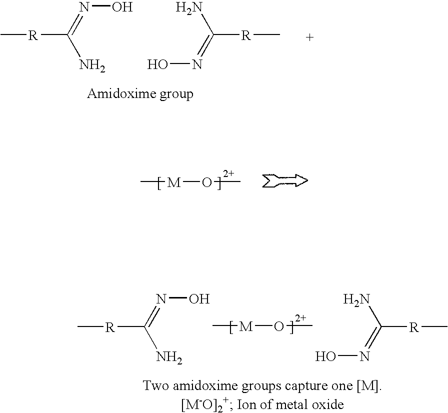

With reference to the present invention, as hereinafter more fully described, the amidoxime compounds can be applied to applications in the state of the art forming a background to the present invention includes the following U.S. patents, the disclosures of which hereby are incorporated herein, in their respective entireties.

### Examples of Embodiments of the Present Invention

### Exemplary Embodiments of the Present Invention

All patents and other published documents cited in the specification are intended to be incorporated herein by reference in their entireties.

### EXAMPLE 1

In an exemplary embodiment of the invention, organometallic and organosilicate residues remaining after a dry etch process from semiconductor substrates were removed. The substrate was exposed to a conditioning solution of phosphoric acid, hydrofluoric acid, and a carboxylic acid, such as acetic acid, which removed the remaining dry etch residues while minimizing removal of material from desired substrate features. The approximate proportions of the conditioning solution were typically 80 to 95 percent by weight of the amidoxime compound and acetic acid, 1 to 15 percent by weight phosphoric acid, and 0.01 to 5.0 percent by weight hydrofluoric acid. See, e.g., U.S. Pat. No. 7,261,835.

In another exemplary embodiment, the composition included from about 0.5% to about 24% by weight of at least one complexing agent with an amidoxime functional group with an aqueous semiconductor cleaning solution having a pH between about 1.5 and about 6 and comprising: at least about 75% by weight of a mixture of water and an organic solvent; from about 0.5% to about 10% by weight of phosphoric acid; optionally one or more other acid compounds; optionally one or more fluoride-containing compounds; and at least one alkaline compound selected from the group consisting of: a trialkylammonium hydroxide and/or a tetraalkylammonium hydroxide; a hydroxylamine derivative; and one or more alkanolamines.

### EXAMPLE 2

Table 1 lists additional exemplary embodiments of the present invention where the formulations additionally include from about 0.5% to about 24% by weight of amidoxime compounds in aqueous semiconductor cleaning solutions. Such formulations may contain additional components consistent with this application such as surfactants, alkaline components, and organic solvents.

TABLE 1
Exemplary Formulations with Chelating Agents for Use with Amidoxime
Compounds

| H₃PO₄ (wt %) | Other Acid | wt % |
|---|---|---|
| 2 | methanesulfonic | 1.47 |
| 2 | pyrophosphoric acid (PPA) | 3.0 |
| 2 | Fluorosicilic | 0.24 |
| 2 | Oxalic | 2.0 |
| 4 | Oxalic | 2.0 |
| 6 | Glycolic | 1.0 |
| 3 | Oxalic | 2.0 |
| 3 | Lactic | 2.0 |
| 4 | Lactic | 2.0 |
| 3 | Citric | 2.0 |
| 4 | Citric | 2.0 |
| 3 | PPA | 0.5 |
| 3 | Glycolic | 2.0 |
| 6 | Glycolic | 2.0 |
| 3 | PPA | 2.0 |
| 3 | PPA | 4.0 |

### EXAMPLE 3

Another exemplary embodiment of the invention relates to a composition for cleaning or etching a semiconductor substrate and a method for using the same. The compositions include from about 0.01% to about 50%, such as about 0.5% to about 24% by weight of amidoxime compounds and may include a fluorine-containing compound as an active agent such as, for example, a quaternary ammonium fluoride, a quaternary phosphonium fluoride, sulfonium fluoride, more generally an -onium fluoride or “multi” quaternary-onium fluoride that includes two or more quaternary-onium groups linked together by one or more carbon-containing groups. The composition may further include a pH adjusting acid such as a mineral acid, carboxylic acid, dicarboxylic acid, sulfonic acid, or combination thereof to give a pH of about 2 to 9. The composition may be anhydrous and may further include an organic solvent such as an alcohol, amide, ether, or combination thereof. These compositions are useful for obtaining improved etch rate, etch selectivity, etch uniformity and cleaning criteria on a variety of substrates.

### EXAMPLE 4

In another exemplary embodiment, the present invention can be used with methods and compositions for removing silicon-containing sacrificial layers from Micro Electro Mechanical System (MEMS) and other semiconductor substrates having such sacrificial layers is described. The etching compositions include a supercritical fluid (SCF), an etchant species, a co-solvent, chelating agent containing at least one amidoxime group, and optionally a surfactant. Such etching compositions overcome the intrinsic deficiency of SCFs as cleaning reagents, viz., the non-polar character of SCFs and their associated inability to solubilize polar species that must be removed from the semiconductor substrate. The resultant etched substrates experience lower incidents of stiction relative to substrates etched using conventional wet etching techniques. See U.S. Pat. No. 7,160,815.

### EXAMPLE 5

In another exemplary embodiment, the invention uses a supercritical fluid (SFC)-based composition, comprising at least one co-solvent, at least one etchant species, and optionally at least one surfactant, wherein said at least one etchant comprises an alkyl phosphonium difluoride and wherein said SFC-based composition is useful for etching sacrificial silicon-containing layers, said compositions containing from about 0.01% to about 50% by weight, preferably about 0.5% to about 24%, of compounds with one or more chelating groups, at least one being an amidoxime functional group. In another exemplary embodiment, the surfactant comprises at least one nonionic or anionic surfactant, or a combination thereof In a particular embodiment, the surfactant is a nonionic surfactant selected from the group consisting of fluoroalkyl surfactants, polyethylene glycols, polypropylene glycols, polyethylene ethers, polypropylene glycol ethers, carboxylic acid salts, dodecylbenzenesulfonic acid; dodecylbeuzenesulfonic salts, polyacrylate polymers, dinonylphenyl polyoxyethylene, silicone polymers, modified silicone polmyers, acetylenic diols, modified acetylenic diols, alkylammonium salts, modified alkylammonium salts, and combinations comprising at least one of the foregoing.

### EXAMPLE 6

Another exemplary embodiment of the present invention is a composition for use in semiconductor processing wherein the composition comprises water, phosphoric acid, and an organic acid. In a particular embodiment, the organic acid is ascorbic acid or an organic acid having two or more carboxylic acid groups (e.g., citric acid). These compositions contain from about 0.01% to about 50% by weight, such as about 0.5% to about 24%, of compounds with one or more chelating groups/agents, at least one being an amidoxime functional group/compound and such compounds can be present in addition to, part of, or in substitution of the organic acid. Water can be present in about 40 wt. % to about 85 wt. % of the composition, the phosphoric acid may be present in about 0.01 wt. % to about 10 wt. % of the composition, and the organic acid may be present in about 10 wt. % to about 60 wt. % of the composition. These compositions may be used for cleaning various surfaces, such as, for example, patterned metal layers and vias by exposing the surfaces to the composition. See U.S. Pat. No. 7,135,444.

### EXAMPLE 7

In an exemplary embodiment, the present invention is used with a polishing liquid composition for polishing a surface, with one particular embodiment comprising an insulating layer and a metal layer, the polishing liquid composition comprising a compound having six or more carbon atoms and a structure in which each of two or more adjacent carbon atoms has a hydroxyl group in a molecule, and water, wherein the compound having a structure in which each of two or more adjacent carbon atoms has a hydroxyl group in a molecule is represented by the formula (I): R¹—X—(CH₂)_{q}—[CH(OH)]ₙ—CH₂OH (I) wherein R¹ is a hydrocarbon group having 1 to 12 carbon atoms; X is a group represented by (CH₂)ₘ, wherein m is 1, an oxygen atom, a sulfur atom, a COO group, a OCO group, a group represented by NR² or O(R²O)P(O)O, wherein R² is hydrogen atom or a hydrocarbon group having 1 to 24 carbon atoms; q is 0 or 1; and n is an integer of 1 to 4, and further comprising from about 0.01%. to about 50% by weight, such as about 0.5% to about 24%, of at least one compound with one or more chelating groups/agents, at least one being an amidoxime functional group/compound, and such compounds may be present in addition to, part of, or in substitution of an organic acid. In a particular embodiment, the composition includes an abrasive. See U.S. Pat. No. 7,118,685.

### EXAMPLE 8

Another exemplary embodiment of the present invention is a composition for use in semiconductor processing wherein the composition comprises water, phosphoric acid, and an organic acid; wherein the organic acid is ascorbic acid or is an organic acid having two or more carboxylic acid groups (e.g., citric acid), further comprising from about 0.01% to about 50% by weight, such as about 0.5% to about 24%, of at least one compound with one or more chelating groups/agents, at least one being an amidoxime functional group/compound and such compounds may be present in addition to, part of, or in substitution of the organic acid. The water may be present in about 40 wt. % to about 85 wt. % of the composition, the phosphoric acid may be present in about 0.01 wt. % to about 10 wt. % of the composition, and the organic acid may be present in about 10 wt. % to about 60 wt. % of the composition. The composition may be used for cleaning various surfaces, such as, for example, patterned metal layers and vias by exposing the surfaces to the composition. See U.S. Pat. Nos. 7,087,561; 7,067,466; and 7,029,588.

### EXAMPLE 9

In another exemplary embodiment of the present invention, from about 0.01% to about 50% by weight, such as about 0.5% to about 24%, of at least one compound with one or more chelating groups/agents, at least one being an amidoxime functional group/compound may be used with an oxidizing solution in a process for the in situ oxidation of contaminants, including, for example, hydrocarbon, organic, bacterial, phosphonic acid, and other contaminants, the contaminants being found in various surfaces and media, including soil, sludge, and water. In a particular embodiment, the solution further includes a peroxygen compound, such as, for example, hydrogen peroxide, in solution with a pre-mixed solution of a carboxylic acid and a halogen salt, such as, for example, glycolic acid and sodium bromide, respectively.

### EXAMPLE 10

In another exemplary embodiment of the present invention from about 0.01% to about 5% by weight, such as about 0.01 to about 0.1% of at least one compound with one or more chelating groups/agents, at least one being an amidoxime functional group/compound may be used with a chemical mechanical polishing slurry that is free of a heteropolyacid and containing about 3 to about 5 percent of an abrasive, about 3 to about 5 percent of hydrogen peroxide, about 0.05 to about 0.1 percent of citric acid, about 0.05 to about 0.5 percent of an iminodiacetic acid, about 0.005 to about 0.02 percent of ammonia, and about 85-90 percent of water, wherein the abrasive contains polymethylmethacrylate. See U.S. Pat. No. 7,029,373.

### EXAMPLE 11

In another exemplary embodiment of the present invention, a non-corrosive cleaning composition for removing residues from a substrate comprises: (a) water; (b) at least one hydroxyl ammonium compound; (c) at least one basic compound, selected in a particular embodiment from the group consisting of amines and quaternary ammonium hydroxides; (d) at least one organic carboxylic acid; (e) from about 0.01% to about 50% by weight, such as about 0.5% to about 24%, of at least one compound with one or more chelating groups/agents, at least one being an amidoxime functional group/compound, and such compounds may be present in addition to, part of, or in substitution of the organic acid; and (f) optionally, a polyhydric compound. In an exemplary embodiment, the pH of the composition is between about 2 to about 6. See U.S. Pat. No. 7,001,874.

### EXAMPLE 12

In an exemplary embodiment, the present invention may also be used with a cleaning solution where the cleaning solution also contains one of a polyvalent carboxylic acid and/or its salt, where in particular embodiments, the polyvalent carboxylic acid is at least one selected from the group consisting of oxalic acid, citric acid, malic acid, maleic acid, succinic acid, tartaric acid, and malonic acid, wherein the cleaning solution contains from about 0.01% to about 50% by weight, such as about 0.5% to about 24%, of at least one compound with one or more chelating groups/agents, at least one being an amidoxime functional group/compound, and such compounds may be present in addition to, part of, or in substitution of the organic acid, which may be used in addition to, as part of, in substitution of the polyvalent carboxylic acid. In a particular embodiment, the cleaning solution further contains a polyamino carboxylic acid and/or its salt. See U.S. Pat. No. 6,998,352.

### EXAMPLE 13

A further exemplary embodiment of the present invention is a method of chemically-mechanically polishing a substrate, which method comprises: (i) contacting a substrate comprising at least one layer of ruthenium and at least one layer of copper with a polishing pad and a chemical-mechanical polishing composition comprising; (a) an abrasive consisting of αalumina treated with a negatively-charged polymer or copolymer, (b) hydrogen peroxide, (c) from about 0.01% to about 50% by weight, such as about 0.5% to about 24% of at least one compound with one or more chelating groups/agents, at least one being an amidoxime functional group/compound; (d) at least one heterocyclic compound, wherein the at least one heterocyclic compound comprises at least one nitrogen atom, (e) a phosphonic acid, and (f) water; (ii) moving the polishing pad relative to the substrate; and (iii) abrading at least a portion of the substrate to polish the substrate, wherein the pH of the water and any components dissolved or suspended therein is about 6 to about 12, wherein the at least one layer of ruthenium and at least one layer of copper are in electrical contact and are in contact with the polishing composition, wherein the difference between the open circuit potential of copper and the open circuit potential of ruthenium in the water and any components dissolved or suspended therein is about 50 mV or less, and wherein a selectivity for polishing copper as compared to ruthenium is about 2 or less.

### EXAMPLE 14

Another exemplary embodiment of the present invention is a semiconductor wafer cleaning formulation, including 1-21% wt. of a fluoride source, 20-55% wt. of organic amine(s), 0.5-40% wt. of a nitrogenous component such as a nitrogen-containing carboxylic acid or an imine, 23-50% wt. of water, and 0-21% wt. of at least one compound with one or more chelating groups/agents, at least one being an amidoxime functional group/compound. These formulations are useful to remove residue from wafers following a resist plasma ashing step, such as, for example, inorganic residue from semiconductor wafers containing delicate copper interconnecting structures. See U.S. Pat. No. 6,967,169.

### EXAMPLE 15

An exemplary embodiment of the present invention also includes a method for chemical mechanical polishing copper, barrier material and dielectric material, the method comprises the steps of: a) providing a first chemical mechanical polishing slurry comprising (i) 1-10 wt. % of silica particles, (ii) 1-12 wt. % of an oxidizing agent, and (iii) 0-2 wt. % of a corrosion inhibitor and a cleaning agent, wherein said first slurry has a hiaher removal rate on copper relative to a lower removal rate on said barrier material; b) chemical mechanical polishing a semiconductor wafer surface with said first slurry; c) providing a second chemical mechanical polishing slurry comprising (i) 1-10 wt. % of silica particles, (ii) 0.1-1.5 wt. % of an oxidizing agent, and (iii) 0.1-2 wt. % of a carboxylic acid, having a pH in a range from about 2 to about 5, wherein the amount of (ii) is not more than the amount of (iii), and wherein said second slurry has a higher removal rate on said barrier material relative to a lower removal rate on said dielectric material and an intermediate removal rate on copper; and d) chemical mechanical polishing said semiconductor wafer surface with said second slurry, wherein either or both slurries contains from about 0.01% to about 50% by weight, such as about 0.5% to about 24%, of at least one compound with one or more chelating groups/agents, at least one being an amidoxime functional group/compound. See U.S. Pat. No. 6,936,542.

### EXAMPLE 16

An exemplary embodiment of the present invention further includes a method for cleaning a surface of a substrate, which comprises at least the following steps (1) and (2), wherein the step (2) is carried out after carrying out the step (1): Step (1): a cleaning step of cleaning the surface of the substrate with an alkaline cleaning agent containing a complexing agent, and Step (2): a cleaning step employing a cleaning agent having a hydrofluoric acid content C (wt %) of from 0.03 to 3 wt %, the complexing agent is from about 0.01% to about 50% by weight, such as about 0.5% to about 24%, of at least one compound with one or more chelating groups/agents, at least one being an amidoxime functional group/compound. See U.S. Pat. No. 6,896,74.

### EXAMPLE 17

Another exemplary embodiment of the present invention is a cleaning gas that is obtained by vaporizing a carboxylic acid and/or a compound with one or more chelating groups/agents, at least one being an amidoxime functional group/compound which is supplied into a treatment chamber having an insulating substance adhering to the inside thereof, and the inside of the treatment chamber is evacuated. When the cleaning gas supplied into the treatment chamber comes in contact with the insulating substance adhering to an inside wall and a susceptor in the treatment chamber, the insulating substance is turned into a complex, so that the complex of the insulating substance is formed. The complex of the insulating substance is easily vaporized due to its high vapor pressure. The vaporized complex of the insulating substance is discharged out of the treatment chamber by the evacuation. See U.S. Pat. No. 6,893,964.

### EXAMPLE 18

An exemplary embodiment of the present invention is a method for rinsing metallized semiconductor substrates following treatment of the substrates with an etch residue removal chemistry, the method comprising the steps of: providing at least one metallized semiconductor substrate, the substrate having etch residue removal chemistry thereon, wherein the etch residue removal chemistry includes N-methylpyrrolidinone; rinsing the etch residue removal chemistry from the substrate and minimizing metal corrosion of the substrate by rinsing the substrate with an aqueous medium comprising an anti-corrosive agent including an organic acid selected from the group consisting of mono- and polycarboxylic acids in an amount effective to minimize metal corrosion; removing the aqueous medium from the process vessel; and introducing a drying vapor into the process vessel which the substrate remains substantially stationary within the process vessel, wherein the remover includes from about 0.01% to about 50% by weight, such as about 0.5% to about 24%, of compounds with one or more chelating groups/agents, at least one being an amidoxime functional group/compound, which may be present in addition to, part of, or in substitution of the organic acid. In a particular embodiment, the composition may further include acetic acid. See U.S. Pat. No. 6,878,213.

### EXAMPLE 19

An exemplary embodiment of the present invention may also be used with the compositions of U.S. Pat. No. 6,849,200 wherein the iminodiacetic acid component is supplemented by or substituted with at least one compound with one or more chelating groups/agents, at least one being an amidoxime functional group/compound.

### EXAMPLE 20

An exemplary embodiment of the present invention also includes a method of cleaning a surface of a copper-containing material by exposing the surface to an acidic mixture comprising NO₃—, F—, and one or more compounds with one or more chelating groups/agents, at least one being an amidoxime functional group/compound. In a particular embodiment, the mixture may also include one or more organic acids to remove at least some of the particles. See U.S. Pat. No. 6,835,668.

### EXAMPLE 21

An exemplary embodiment of the present invention also includes a cleaning composition comprising at least one of fluoride salts and hydrogen difluoride salts; an organic solvent having at least one heteroatom; optionally one or more surfactants in an amount of from 0.0001 to 10.0%; water and from about 0.01% to about 50% by weight, such as about 0.5 % to about 24%, of at least one compound with one or more chelating groups/agents, at least one being an amidoxime functional group/compound. See U.S. Pat. No. 6,831,048.

### EXAMPLE 22

An exemplary embodiment of the present invention further includes a glycol-free composition for cleaning a semiconductor substrate, the composition containing (a) an acidic buffer solution containing an acid selected from a carboxylic acid and a polybasic acid and an ammonium salt of the acid in a molar ratio of acid to ammonium salt ranging from 10:1 to 1:10 and wherein the acidic buffer solution is present in an amount sufficient to maintain a pH of the composition from about 3 to about 6, (b) from 30% by weight to 90% by weight of an organic polar solvent that is miscible in all proportions in water, (c) from 0.1% by weight to 20% by weight of fluoride, (d) from 0.5% by weight to 40% by weight of water and (e) optionally up to 15% by weight of a corrosion inhibitor. The composition further contains from about 0.01% to about 50% by weight, such as about 0.5% to about 24%, of compounds with one or more chelating groups/agents, at least one being an amidoxime functional group/compound or such compounds may be used in place of the corrosion inhibitor. See U.S. Pat. No. 6,828,289.

### EXAMPLE 23

An exemplary embodiment of the present invention further includes compositions containing AEEA and or AEEA derivatives which can be present in an amount ranging from about 1% to about 99%, such as about 10% to about 85%. For each AEEA range given for various compositions described herein, there is a “high-AEEA” embodiment where the amount of AEEA is in the upper half of the range, and a “low-AEEA” embodiment where AEEA is present in an amount bounded by the lower half of the range. Generally, the higher AEEA embodiments exhibit lower etch rates than the low AEEA embodiments for selected substrates, with particular embodiments further including from about 0.01% to about 50% by weight, such as about 0.5% to about 24%, of compounds with one or more chelating groups/agents, at least one being an amidoxime functional group/compound. In particular embodiments, these compositions also include other compounds, particularly polar organic solvents, water, alkanolamines, hydroxylamines, additional chelating agents, and/or corrosion inhibitors. See U.S. Pat. No. 6,825,156.

### EXAMPLE 24

A exemplary composition for the stripping of photoresist and the cleaning of residues from substrates, and for silicon oxide etch, comprises from about 0.01 percent by weight to about 10 percent by weight of one or more fluoride compounds, from about 10 percent by weight to about 95% by weight of a sulfoxide or sulfone solvent, and from about 20 percent by weight to about 50 percent by weight water, further including from about 0.01% to about 50% by weight, such as about 0.5% to about 24%, of compounds with one or more chelating groups/agents, at least one being an amidoxime functional group/compound. In a particular embodiment, the composition may contain corrosion inhibitors, chelating agents, co-solvents, basic amine compounds, surfactants, acids and bases. See U.S. Pat. No. 6,777,380.

### EXAMPLE 25

An exemplary polishing composition for polishing a semiconductor substrate has a pH of under 5.0 and comprises (a) a carboxylic acid polymer comprising polymerized unsaturated carboxylic acid monomers having a number average molecular weight of about 20,000 to 1,500,000 or blends of high and low number average molecular weight polymers of polymerized unsaturated carboxylic acid monomers, (b) 1 to 15% by weight of an oxidizing agent, (c) up to 3.0% by weight of abrasive particles, (d) 50-5,000 ppm (parts per million) of an inhibitor, (e) up to 3.0% by weight of a complexing agent, such as, malic acid, and (f) 0.1 to 5.0% by weight of a surfactant, from about 0.01% to about 50% by weight, such as about 0.5% to about 24%, of at least one compound with one or more chelating groups/agents, at least one being an amidoxime functional group/compound. See U.S. Pat. No. 6,679,928.

### EXAMPLE 26

In an exemplary embodiment, particulate and metal ion contamination is removed from a surface, such as a semiconductor wafer containing copper damascene or dual damascene features, employing aqueous composition comprising a fluoride containing compound; a dicarboxylic acid and/or salt thereof; and a hydroxycarboxylic acid and/or salt thereof, the composition contains from about 0.01% to about 50% by weight, such as about 0.5% to about 24%, of at least one compound with one or more chelating groups/agents, at least one being an amidoxime functional group/compound. See U.S. Pat. No. 6,673,757.

### EXAMPLE 27

An exemplary semiconductor wafer cleaning formulation comprises 2-98% wt. of an organic amine, 0-50% wt. of water, 0.1-60% wt. of a 1,3-dicarbonyl compound chelating agent, 0-25% wt. of an additional different chelating agent(s), 0.5-40% wt. of a nitrogen-containing carboxylic acid or an imine, and 2-98% wt of a polar organic solvent. These formulations are useful to remove residue from wafers following a resist plasma ashing step, such as inorganic residue from semiconductor wafers containing delicate copper interconnecting structures.

### EXAMPLE 28

Another exemplary embodiment of the present invention relates to a method useful in removing etch residue from etcher equipment parts. The compositions used are aqueous, acidic compositions containing fluoride and polar, organic solvents. These compositions are free of glycols and hydroxyl amine and have a low surface tension and viscosity and further include from about 0.01% to about 50% by weight, such as about 0.5% to about 24%, of at least one compound with one or more chelating groups/agents, at least one being an amidoxime functional group/compound. See U.S. Pat. No. 6,656,894.

### EXAMPLE 29

An exemplary embodiment of the invention includes a method of cleaning a surface of a copper-containing material by exposing the surface to an acidic mixture comprising NO₃—, F— and from about 0.01% to about 50% by weight, such as about 0.5% to about 24%, of at least one compound with one or more chelating groups/agents, at least one being an amidoxime functional group/compound and/or one or more organic acid anions having carboxylate groups. An exemplary embodiment of the invention also includes an improved semiconductor processing method of forming an opening to a copper-containing material. A mass is formed over a copper-containing material within an opening in a substrate. The mass contains at least one of an oxide barrier material and a dielectric material. A second opening is etched through the mass into the copper containing material to form a base surface of the copper-containing material that is at least partially covered by particles comprising at least one of a copper oxide, a silicon oxide or a copper fluoride. The base surface is cleaned with a solution comprising nitric acid, hydrofluoric acid and one or more organic acids to remove at least some of the particles.

In an exemplary embodiment, one or more organic acids may be used in the composition. In a particular embodiment, the composition includes an acetic acid solution (99.8%, by weight in water), an HF solution (49%, by weight in water), an HNO₃ solution (70.4%, by weight in water), and H₂O, the resulting cleaning mixture containing from about 3% to about 20% of at least one compound with one or more chelating groups/agents, at least one being an amidoxime functional group/compound, by weight; from about 0.1% to about 2.0% HNO₃ by weight; and from about 0.05% to about 3.0% HF, by weight. See U.S. Pat. No. 6,589,882.

### EXAMPLE 30

Another exemplary embodiment of the present invention is a composition for selective etching of oxides over a metal. The composition contains water, hydroxylammonium salt, one or more compounds with one or more chelating groups/agents, at least one being an amidoxime functional group/compound, a fluorine-containing compound, and optionally, a base. The pH of the composition is about 2 to 6. See U.S. Pat. No. 6,589,439.

### EXAMPLE 31

Another exemplary embodiment of the present invention is an etching treatment comprising a combination including hydrofluoric acid of 15 percent by weight to 19 percent by weight, one or more compounds with one or more chelating groups/agents, at least one being an amidoxime functional group/compound of 0.5 percent by weight to 24 percent by weight and ammonium fluoride of 12 percent by weight to 42 percent by weight, said combination having a hydrogen ion concentration of 10⁻⁶ mol/L to 10^{-1.8}, further comprising a surfactant of 0.001 percent by weight to 1 percent by weight. See U.S. Pat. No. 6,585,910.

### EXAMPLE 32

Another exemplary embodiment of the present invention includes a semiconductor wafer cleaning formulation, including 2-98% wt. of an organic amine, 0-50% wt. of water, 0.1-60% wt. of one or more compounds with one or more chelating groups/agents, at least one being an amidoxime functional group/compound, 0-25% wt, of additional different chelating agent(s), 0.1-40% wt. of a nitrogen-containing carboxylic acid or an imine, optionally a 1,3-dicarbonyl compound chelating agent, and 2-98% wt of a polar organic solvent. These formulations are useful to remove residue from wafers following a resist plasma ashing step, such as inorganic residue from semiconductor wafers containing delicate copper interconnecting structures. See U.S. Pat. No. 6,566,315.

### EXAMPLE 33

An exemplary embodiment of the present invention is a method for removing organometallic and organosilicate residues remaining after a dry etch process from semiconductor substrates. The substrate is exposed to a conditioning solution of a fluorine source, a non-aqueous solvent, a complementary acid, and a surface passivation agent. In a particular embodiment, the fluorine source is hydrofluoric acid. The non-aqueous solvent may be a polyhydric alcohol such as propylene glycol. The complementary acid may be either a phosphoric acid or hydrochloric acid. The surface passivation agent is one or more compounds with one or more chelating groups/agents, at least one being an amidoxime functional group/compound, and may optionally include a carboxylic acid such as citric acid. Exposing the substrate to the conditioning solution removes the remaining dry etch residues while minimizing removal of material from desired substrate features. See U.S. Pat. No. 6,562,726.

### EXAMPLE 34

Another exemplary embodiment of the present invention is a stripping and cleaning composition for the removal of residue from metal and dielectric surfaces in the manufacture of semi-conductors and microcircuits. The composition is an aqueous system including organic polar solvents including corrosive inhibitor component from one or more compounds with one or more chelating groups/agents, at least one being an amidoxime functional group/compound and optionally a select group of aromatic carboxylic acids used in effective inhibiting amounts. A particular embodiment method for the removal of residues from metal and dielectric surfaces comprises the steps of contacting the metal or dielectric surface with the above inhibited compositions for a time sufficient to remove the residues. See U.S. Pat. No. 6,558,879.

### EXAMPLE 35

Another exemplary embodiment of the present invention is a homogeneous non-aqueous composition containing a fluorinated solvent, ozone, one or more compounds with one or more chelating groups/agents, at least one being an amidoxime functional group/compound, and optionally a co-solvent and the use of these compositions for cleaning and oxidizing substrates is described. See U.S. Pat. No. 6,537,380.

### EXAMPLE 36

An exemplary embodiment of the present invention also includes a chemical mechanical polishing slurry and method for using the slurry for polishing copper, barrier material and dielectric material that comprises a first and second slurry. The first slurry has a high removal rate on copper and a low removal rate on barrier material. The second slurry has a high removal rate on barrier material and a low removal rate on copper and dielectric material. The first and second slurries at least comprise silica particles, an oxidizing agent, one or more compounds with one or more chelating groups/agents, at least one being an amidoxime functional group/compound, optionally a corrosion inhibitor, and a cleaning agent. See, U.S. Pat. No. 6,527,819.

### EXAMPLE 37

Another exemplary embodiment of the present invention also includes a method for removing organometallic and organosilicate residues remaining after a dry etch process from semiconductor substrates. The substrate is exposed to a conditioning solution of phosphoric acid, hydrofluoric acid, and one or more compounds with one or more chelating groups/agents, at least one being an amidoxime functional group/compound, and optionally a carboxylic acid, such as acetic acid, which removes the remaining dry etch residues while minimizing removal of material from desired substrate features. The approximate proportions of the conditioning solution are typically 80 to 95 percent by weight one or more compounds with one or more chelating groups/agents, at least one being an amidoxime functional group/compound and carboxylic acid, 1 to 15 percent by weight phosphoric acid, and 0.01 to 5.0 percent by weight hydrofluoric acid. See U.S. Pat. No. 6,517,738.

### EXAMPLE 38

Another exemplary embodiment of the present invention is a composition for use in semiconductor processing wherein the composition comprises water, phosphoric acid, and one or more compounds with one or more chelating groups/agents, at least one being an amidoxime functional group/compound, and optionally an organic acid; wherein the organic acid is ascorbic acid or is an organic acid having two or more carboxylic acid groups (e.g., citic acid). The water may be present in about 40 wt. % to about 85 wt. % of the composition, the phosphoric acid may be present in about 0.01 wt. % to about 10 wt. % of the composition, and the one or more compounds with one or more chelating groups/agents, at least one being an amidoxime functional group/compound and organic acid may be present in about 10 wt. % to about 60 wt. % of the composition. The composition may be used for cleaning various surfaces, such as, for example, patterned metal layers and vias by exposing the surfaces to the composition. See U.S. Pat. No. 6,486,108.

### EXAMPLE 39

Another exemplary embodiment of the present invention is a method for removing organometallic and organosilicate residues remaining after a dry etch process from semiconductor substrates. The substrate is exposed to a conditioning solution of phosphoric acid, hydrofluoric acid, and one or more compounds with one or more chelating groups/agents, at least one being an amidoxime functional group/compound, and optionally a carboxylic acid, such as acetic acid, which removes the remaining dry etch residues while minimizing removal of material from desired substrate features. In a particular embodiment, the approximate proportions of the conditioning solution are 80 to 95 percent by weight one or more compounds with one or more chelating groups/agents, at least one being an amidoxime functional group/compound and acetic acid, 1 to 15 percent by weight phosphoric acid, and 0.01 to 5.0 percent by weight hydrofluoric acid. See U.S. Pat. No. 6,453,914.

### EXAMPLE 40

Another exemplary example of the present invention is a method for cleaning a substrate which has a metal material and a semiconductor material both exposed at the surface and which has been subjected to a chemical mechanical polishing treatment, the substrate is first cleaned with a first cleaning solution containing ammonia water, etc. and then with a second cleaning solution containing (a) a first complexing agent capable of easily forming a complex with the oxide of said metal material, etc. and (b) an anionic or cationic surfactant. See U.S. Pat. No. 6,444,583.

### EXAMPLE 41

An exemplary embodiment of the present invention is a cleaning agent for semiconductor parts, which can decrease a load on the environment and has a high cleaning effect on CMP (chemical mechanical polishing) abrasive particles, metallic impurities and other impurities left on the semiconductor parts such as semiconductor substrates after the CMP, comprising a (co)polymer having one or more compounds with one or more chelating groups/agents, at least one being an amidoxime functional group/compound, and optionally at least one kind of group selected from the group consisting of sulfonic acid (salt) groups and carboxylic acid (salt) groups, the cleaning agent further containing a phosphonic acid (salt) group-containing (co)polymer, a phosphonic acid compound or a surfactant as needed; and a method for cleaning semiconductor parts with the above cleaning agent. See U.S. Pat. No. 6,440,856.

### EXAMPLE 42

An exemplary embodiment of the present invention includes a non-corrosive cleaning composition for removing residues from a substrate. The composition comprises: (a) water; (b) at least one hydroxylammonium compound; (c) at least one basic compound selected from the group consisting of amines and quaternary ammonium hydroxides; (d) one or more compounds with one or more chelating groups/agents, at least one being an amidoxime functional group/compound, (e) optionally at least one organic carboxylic acid; and (f) optionally, a polyhydric compound. The pH of the composition is preferably between about 2 to about 6. See U.S. Pat. No. 6,413,923.

### EXAMPLE 43

Another exemplary embodiment of the present invention is a composition comprising a slurry having an acidic pH and a corrosion inhibitor with one or more compounds with one or more chelating groups/agents, at least one being an amidoxime functional group/compound, and optionally a carboxylic acid corrosion inhibitor, wherein said carboxylic acid is selected from the group consisting of: glycine, oxalic acid, malonic acid, succinic acid and nitrilotriacetic acid. See U.S. Pat. No. 6,409,781.

### EXAMPLE 44

An exemplary embodiment of the present invention is a chemical formulation containing a chelating agent, wherein said chelating agent is one or more compounds with one or more chelating groups/agents, at least one being an amidoxime functional group/compound, and optionally one or more additional chelating agents selected from the group consisting of iminodiacetic, malonic, oxalic, succinic, boric and nialic acids and 2,4pentanedione; a fluoride source; and a glycol solvent, wherein said chelating agents consist of approximately 0.1-10% by weight of the formulation; and wherein said fluoride source is a compound selected from the group consisting of ammonium fluoride, an organic derivative of ammonium fluoride, and a organic derivative of a polyammonium fluoride; and wherein said fluoride source contains approximately 1.65-7% by weight of the formulation; and wherein said glycol solvent consists of approximately 73-98.25% by weight of said formulation, further comprising; an amine, wherein said amine consists of approximately 0.1-10% by weight of said formulation. The chelating agents may contain one or more compounds with one or more chelating groups/agents, at least one being an amidoxime functional group/compound, and optionally contain two carboxylic acid groups or two hydroxyl groups or two carbonyl groups such that the two groups in the chelating agent are in close proximity to each other. Other chelating agents which are also weakly to moderately acidic and are structurally similar to those claimed are also expected to be suitable. See U.S. Pat. No. 6,383,410.

### EXAMPLE 45

Another exemplary embodiment of the present invention is a cleaning composition comprising a partially fluorinated solvent, a co-solvent, one or more compounds with one or more chelating groups/agents, at least one being an amidoxime functional group/compound, and ozone, wherein said fluorinated solvent comprises hydrofluoroethers, wherein said co-solvent is selected from the group consisting of ethers, esters, tertiary alcohols, carboxylic acids, ketones and aliphatic hydrocarbons. See U.S. Pat. No. 6,372,700.

### EXAMPLE 46

Another exemplary embodiment of the present invention is a combination of one or more compounds with one or more chelating groups/agents, at least one being an amidoxime functional group/compound and optionally a carboxylic acid corrosion inhibitor. The combination of corrosion inhibitors can effectively inhibit metal corrosion of aluminum, copper, and their alloys. Suitable carboxylic acids include monocarboxylic and polycarboxylic acids. For example, the carboxylic acid may be, but is not limited to, formic acid, propionic acid, valeric acid, isovaleric acid, oxalic acid, malonic acid, succinic acid, glutaric acid, maleic acid, filmaric acid, phthalic acid, 1,2,3-benzenetricarboxylic acid, glycolic acid, lactic acid, citric acid, salicylic acid, tartaric acid, gluconic acid, and mixtures thereof. In a particular embodiment, the carboxylic acid is citric acid.

### EXAMPLE 47

Another exemplary embodiment of the present invention is a composition for selective etching of oxides over a metal comprising: (a) water; (b) hydroxylammonium salt in an amount about 0.1 wt. % to about 0.5 wt. % of said composition; (c) one or more compounds with one or more chelating groups/agents, at least one being an amidoxime functional group/compound; (d) optionally a carboxylic acid selected from the group consisting of, but not limited to, formic acid, acetic acid, propionic acid, valeric acid, isovaleric acid, oxalic acid, malonic acid, succinic acid, glutaric acid, maleic acid, fimaric acid, phthalic acid, 1,2,3-benzenetricarboxylic acid, glycolic acid, lactic acid, citric acid, salicylic acid, tartaric acid, gluconic acid, and mixtures thereof; (e) a fluorine-containing compound; and (e) optionally, base. See U.S. Pat. No. 6,361,712.

### EXAMPLE 48

In an exemplary embodiment, the invention relates to a semiconductor wafer cleaning formulation for use in post plasma ashing semiconductor fabrication, comprising the following components in the percentage by weight (based on the total weight of the formulation) ranges shown:

| | |
|---|---|
| Organic amine(s) | 2-98% by weight |
| Water | 0-50% by weight |
| amidoxime chelating agent | 0.1-60% by weight |
| Complexing agent | 0-25% by weight |
| Nitrogen-containing carboxylic | 0.5-40% by weight |
| acid or imine | |
| polar organic solvent | 2-98% by weight. |

### EXAMPLE 49

Another exemplary example of the present invention includes an essentially anhydrous cleaning composition comprising 88 weight percent or more of a fluorinated solvent, from 0.005 to 2 weight percent of hydrogen fluoride or complex thereof, and from 0.01 to 5 weight percent of a co-solvent, wherein said co-solvent is selected from one or more compounds with one or more chelating groups/agents, at least one being an amidoxime functional group/compound, ethers, polyethers, carboxylic acids, primary and secondary alcohols, phenolic alcohols, ketones, aliphatic hydrocarbons and aromatic hydrocarbons. See U.S. Pat. No. 6,310,018.

### EXAMPLE 50

| | | |
|---|---|---|
| A. | Amidoxime compound | 2.5% by weight |
| | Tetramethylammonium fluoride | 4.5% by weight |
| | Ethylene glycol | 93% by weight |
| B. | Amidoxime compound | 1.3% by weight |
| | Pentamethyldiethylenetriammonium trifluoride | 4.6% by weight |
| | Ethylene glycol | 94.1% by weight |
| C. | Amidoxime compound | 1.25% by weight |
| | Triethanolammonium fluoride | 5% by weight |
| | Ethylene glycol | 93.75% by weight |
| D. | Amidoxime compound | 2.8% by weight |
| | Tetramethylammonium fluoride | 5.1% by weight |
| | Ethylene glycol | 92.1% by weight |
| E. | Amidoxime compound | 2% by weight |
| | Ammonium fluoride | 7% by weight |
| | Ethylene glycol | 91% by weight |
| F. | Amidoxime compound | 2.8% by weight |
| | Ammonium fluoride | 5% by weight |
| | Ethylene glycol | 92.2% by weight |

### EXAMPLE 51

Another exemplary embodiment of the present invention includes a chelating agent a fluoride salt, and a glycol solvent, wherein said chelating agent is weakly to moderately acidic, and consists of approximately 0.1-10% by weight of the formulation; and wherein said fluoride salt consists of a compound selected from the group consisting of ammonium fluoride, an organic derivative of ammonium fluoride, and a organic derivative of a polyammonium fluoride; and wherein said fluoride salt consists of approximately 1.65-7% by weight of the formulation; and wherein said glycol solvent consists of 73-98.25% by weight of said formulation; and further including an amine, wherein said amine consists of approximately 0.1-10% by weight of said formulation; and wherein said chelating agent is an amidoxime or hydroxamic acid. See U.S. Pat. No. 6,280,651.

### EXAMPLE 52

Another exemplary example of the present invention is a cleaning agent for use in producing semiconductor devices, which consists essentially of an aqueous solution containing (a) 0.1 to 15% by weight based on the total amount of the cleaning agent of at least one fluorine-containing compound selected from the group consisting of hydrofluoric acid, ammonium fluoride, ammonium hydrogenfluoride, acidic ammonium fluoride, methylamine salt of hydrogen fluoride, ethylamine salt of hydrogen fluoride, propylamine salt of hydrogen fluoride and tetramethylammonium fluoride, (b) 0.1 to 15% by weight based on the total amount of the cleaning agent of a salt of boric acid and (c) 0.5 to 50% by weight of one or more compounds with one or more chelating groups/agents, at least one being an amidoxime functional group/compound; and (d) 5 to 80% by weight based on the total amount of the cleaning agent of a water-soluble organic solvent, and optionally further containing at least one of a quaternary ammonium salt, an ammonium salt of an organic carboxylic acid, an amine salt of an organic carboxylic acid and a surfactant. See U.S. Pat. No. 6,265,309.

### EXAMPLE 53

Another exemplary embodiment of the present invention includes a cleaning liquid in the form of an aqueous solution for cleaning a semiconductor device during production of a semiconductor device, which comprises (a) a fluorine-containing compound; (b) a water-soluble or water-miscible organic solvent; (c) one or more compounds with one or more chelating groups/agents, at least one being an amidoxime functional group/compound; (d) optionally, an organic acid; and (e) a quaternary ammonium salt. In a particular embodiment, the cleaning solution also contains a surfactant. The organic acid may be selected from the group consisting of formic acid, acetic acid, propionic acid, butyric acid, isobutyric acid, valeric acid, isovaleric acid, heptanoic acid, lauric acid, palmitic acid, stearic acid, acrylic acid, crotonic acid, methacrylic acid, oxalic acid, malonic acid, maleic acid, succinic acid, adipic acid, azelaic acid, sebacic acid, benzoic acid, toluic acid, phthalic acid, trimellitic acid, pyromellitic acid, benzenesulfonic acid, toluenesulfonic acid, salicylic acid and phthalic anhydride. See U.S. Pat. No. 5,972,862.

### EXAMPLE 54

Another exemplary embodiment is a method for semiconductor processing comprising etching of oxide layers, especially etching thick SiO₂ layers and/or last step in the cleaning process wherein the oxide layers are etched in the gas phase with a mixture of hydrogen fluoride, one or more compounds with one or more chelating groups/agents, at least one being an amidoxime functional group/compound, and optionally one or more carboxylic acids, eventually in admixture with water. See U.S. Pat. No. 5,922,624.

### EXAMPLE 55

In an exemplary embodiment, the complexing agents of the present invention may also be added to the rinse containing a peroxide of U.S. Pat. No. 5,911,836.

### EXAMPLE 56

Another exemplary example of the present invention is a method and apparatus for increasing the deposition of ions onto a surface, such as the adsorption of uranium ions on the detecting surface of a radionuclide detector. The method includes the step of exposing the surface to one or more compounds with one or more chelating groups/agents, at least one being an amidoxime functional group/compound, and optionally, a phosphate ion solution, which has an affinity for the dissolved species to be deposited on the surface. This embodiment provides, for example, enhanced sensitivity of the radionuclide detector. See U.S. Pat. No. 5,652,013.

### EXAMPLE 57

Another exemplary embodiment of the present invention is a stripping and cleaning agent for removing dry-etching photoresist residues, and a method for forming an aluminum based line pattern using the stripping and cleaning agent. The stripping and cleaning agent contains (a) from 5 to 50% by weight of one or more compounds with one or more chelating groups/agents, at least one being an amidoxime functional group/compound; (b) from 0.5 to 15% by weight of a fluorine compound; and (c) a solvent, including water. The inventive method is advantageously applied to treating a dry-etched semiconductor substrate with the stripping and cleaning agent. The semiconductor substrate comprises a semiconductor wafer having thereon a conductive layer containing aluminum. The conductive layer is dry-etched through a patterned photoresist mask to form a wiring body having etched side walls. The dry etching forms a side wall protection film on the side walls. In accordance with the inventive method, the side wall protection film and other resist residues are completely released without corroding the wiring body. See, U.S. Pat. No. 5,630,904.

### EXAMPLE 58

U.S. Pat. No. 6,927,176 describes the effectiveness of chelating compounds due to their binding sites as illustrated below. It highlights that there are 6 binding sites for ethylenediaminetetraacetic acid (EDTA):

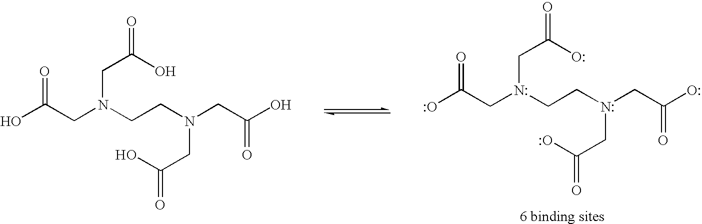

By the same principal applying to a amidoxime from the conversion of a cyanoethylation compound of ethylenediamine, it results a total of 14 binding sites, as depicted in the following:

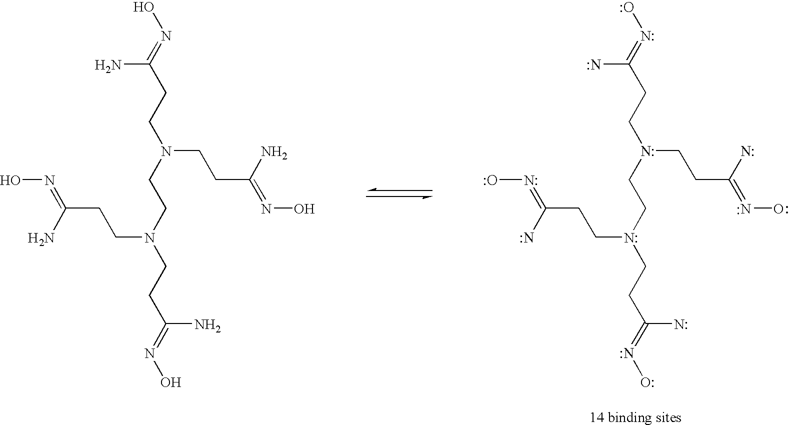

### (1,2,3,4,5,6-(hexa-(2-amidoximo)ethoxy)hexane hexitol

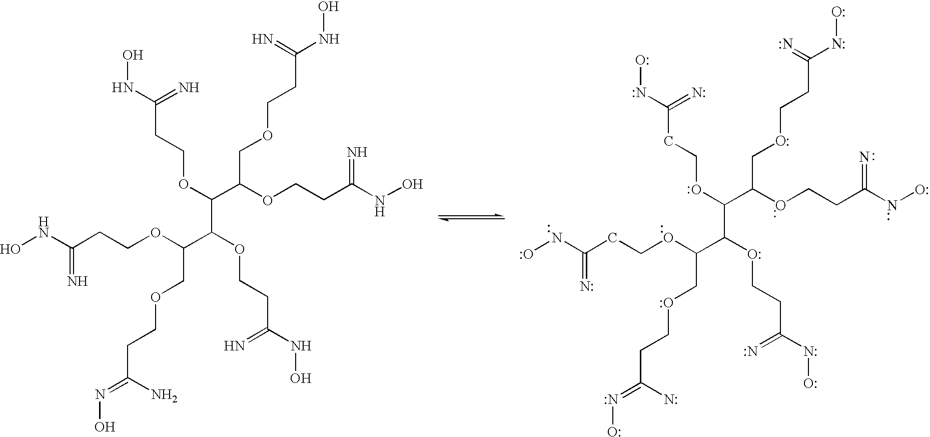

has a total of 18 binding sites. It is more effective in binding metal ions from the etching residues. The claimed amidoxime chelating agent can substitute in application to replace polyacrylates, carbonates, phosphonates, and gluconates, ethylenediaminetetraacetic acid (EDTA), N,N′-bis(2-hydroxyphenyl)ethylenediiminodiacetic acid (HPED), , triethylenetetranitrilohexaacetic acid (TTHA), desferriferrioxamin B,N,N′,N″-tris[2(N-hydroxycarbonyl)ethyl]-1,3,5-benzenetricarboxamide (BAMTPH), and ethylenediaminediorthohydroxyphenylacetic acid (EDDHA).

In an exemplary embodiment, solutions of the present application include compositions comprising:

### A) An Organic Compound With One or More Amidoxime Functional Groups

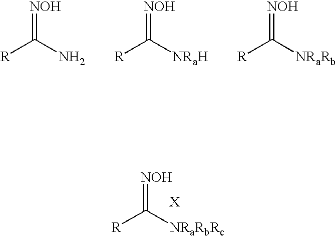

or tautomers thereof, wherein X is a counterion and R, Rₐ, R_{b} and R_{c} are independently selected from alkyl, heteroalkyl, aryl and heteroaryl, and wherein the alkyl, heteroalkyl, aryl and heteroaryl are optionally substituted.

### B) Water

Within the scope of exemplary embodiments of this invention, water may be introduced into the composition essentially only in chemically and/or physically bound form or as a constituent of the raw materials or compounds.

### C) Solvent—From About 1% to 99% By Weight

Exemplary embodiments of the compositions of the present invention include 0% to about 99% by weight, such as about 1% to about 80% by weight of a water miscible organic solvent, where the solvent(s) include, but are not limited to, water miscible organic solvents. Examples of water miscible organic solvents include, but are not limited to, dimethylacetamide (DMAC), N-methyl pyrrolidinone (NMP), N-Ethyl pyrrolidone (NEP), N-Hydroxyethyl Pyrrolidone (HEP), N-Cyclohexyl Pyrrolidone (CHP) dimethylsulfoxide (DMSO), Sulfolane, dimethylformamide (DMF), N-methylformamide (NMF), formamide, Monoethanol amine (MEA), Diglycolamine, dimethyl-2-piperidone (DMPD), morpholin, N-morpholine-N-Oxide (NMNO), tetrahydrofurfuryl alcohol, cyclohexanol, cyclohexanone, polyethylene glycols and polypropylene glycols, glycerol, glycerol carbonate, triacetin, ethylene glycol, propylene glycol, propylene carbonate, hexylene glycol, ethanol and n-propanol and/or isopropanol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy, ethoxy or butoxy triglycol, 1-butoxyethoxy-2-propanol, 3-methyl-3-methoxybutanol, propylene glycol t-butyl ether, and other amides, alcohols or pyrrolidones, ketones, sulfoxides, or multifunctional compounds, such as hydroxyamides or aminoalcohols, and mixtures of these solvents thereof. The preferred solvents, when employed, are dimethyl acetamide and dimethyl-2-piperidone, dimethylsufoxide and N-methylpyrrolidinone, diglycolamine, and monoethanolamine.

### D) Acids—From About 0.001% to 15% By Weight

Exemplary embodiments of the invention include inorganic acids or organic acids, provided that they are compatible with the other components.

Inorganic acids include, but are not limited to, hydrochloric acid, hydrofluoric acid, sulfuric acid, phosphoric acid, phosphorous acid, hypophosphorous acid, phosphonic acid, nitric acid, and the like.

Organic acids include, but are not limited to, monomeric and/or polymeric organic acids from the groups of unbranched saturated or unsaturated monocarboxylic acids, of branched saturated or unsaturated monocarboxylic acids, of saturated and unsaturated dicarboxylic acids, of aromatic mono, di- and tricarboxylic acids, of sugar acids, of hydroxy acids, of oxo acids, of amino acids and/or of polymeric carboxylic acids are preferred.

Unbranched saturated or unsaturated monocarboxylic acids include, but are not limited to, methanoic acid (formic acid), ethanoic acid (acetic acid), propanoic acid (propionic acid), pentanoic acid (valeric acid), hexanoic acid (caproic acid), heptanoic acid (enanthic acid), octanoic acid (caprylic acid), nonanoic acid (pelargonic acid), decanoic acid (capric acid), undecanoic acid, dodecanoic acid (lauric acid), tridecanoic acid, tetradecanoic acid (myristic acid), pentadecanoic acid, hexadecanoic acid (palmitic acid), heptadecanoic acid (margaric acid), octadecanoic acid (stearic acid), eicosanoic acid (arachidic acid), docosanoic acid (behenic acid), tetracosanoic acid (lignoceric acid), hexacosanoic acid (cerotic acid), triacontanoic acid (melissic acid) 9c-hexadecenoic acid (palmitoleic acid), 6c-octadecenoic acid (petroselic acid), 6t-octadecenoic acid (petroselaidic acid), 9c-octadecenoic acid (oleic acid), 9t-octadecenoic acid (elaidic acid), 9c,12c-octadecadienoic acid (linoleic acid), 9t,12t-octadecadienoic acid (linolaidic acid) and 9c,12c,15c-octadecatrienoic acid (linolenic acid).

Branched saturated or unsaturated monocarboxylic acids include, but are not limited to, 2-methylpentanoic acid, 2-ethylhexanoic acid, 2-propylheptanoic acid, 2-butyloctanoic acid, 2-pentylnonanoic acid, 2-hexyldecanoic acid, 2-heptylundecanoic acid, 2-octyldodecanoic acid, 2-nonyltridecanoic acid, 2-decyltetradecanoic acid, 2-undecylpentadecanoic acid, 2-dodecylhexadecanoic acid, 2-tridecylheptadecanoic acid, 2-tetradecyloctadecanoic acid, 2-pentadecylnonadecanoic acid, 2-hexadecyleicosanoic acid, 2-heptadecylheneicosanoic acid.

Unbranched saturated or unsaturated di- or tricarboxylic acids include, but are not limited to, propanedioic acid (malonic acid), butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), 2c-butenedioic acid (maleic acid), 2t-butenedioic acid (fumaric acid), 2-butynedicarboxylic acid (acetylenedicarboxylic acid).

Aromatic mono-, di- and tricarboxylic acids include, but are not limited to, benzoic acid, 2-carboxybenzoic acid (phthalic acid), 3-carboxybenzoic acid (isophthalic acid), 4-carboxybenzoic acid (terephthalic acid), 3,4-dicarboxybenzoic acid (trimellitic acid), and 3,5-dicarboxybenzoic acid (trimesionic acid).

Sugar acids include, but are not limited to, galactonic acid, mannonic acid, fructonic acid, arabinonic acid, xylonic acid, ribonic acid, 2-deoxyribonic acid, alginic acid.

Hydroxy acids include, but are not limited to, hydroxyphenylacetic acid (mandelic acid), 2-hydroxypropionic acid (lactic acid), hydroxysuccinic acid (malic acid), 2,3-dihydroxybutanedioic acid (tartaric acid), 2-hydroxy-1,2,3-propanetricarboxylic acid (citric acid), ascorbic acid, 2-hydroxybenzoic acid (salicylic acid), and 3,4,5-trihydroxybenzoic acid (gallic acid).

Oxo acids include, but are not limited to, 2-oxopropionic acid (pyruvic acid) and 4-oxopentanoic acid (levulinic acid).

Amino acids include, but are not limited to, alanine, valine, leucine, isoleucine, proline, tryptophan, phenylalanine, methionine, glycine, serine, tyrosine, threonine, cysteine, asparagine, glutamine, aspartic acid, glutamic acid, lysine, arginine, and histidine.

### E) Bases from About 1% to 45 % By Weight

Exemplary embodiments of the invention include bases that are either inorganic bases or organic bases provided that they are compatible with the other components.

Inorganic bases include, but are not limited to, sodium hydroxide, lithium hydroxide, potassium hydroxide, ammonium hydroxide and the like.

Organic bases include, but are not limited to, organic amines, and quaternary alkylammonium hydroxide which may include, but are not limited to, tetramethylammonium hydroxide (TMAH), TMAH pentahydrate, benzyltetramethylammonium hydroxide (BTMAH), TBAH, choline, and Tris(2-hydroxyethyl)methylammonium hydroxide (TEMAH).

### F) Activator—from About 0.001% to 25% By Weight

According to exemplary embodiments of the present invention, the cleaning compositions comprise one or more activators. In particular embodiments, the activators include the groups of polyacylated alkylenediamines, in particular tetraacetylethylenediamine (TAED), N-acylimides, in particular N-nonanoylsuccinimide (NOSI), acylated phenolsulfonates, in particular n-nonanoyl- or isononanoyloxybenzenesulfonate (n- or iso-NOBS) and n-methylmorpholiniumacetonitrile, methylsulfate (MMA), and “nitrile quaternary” compound in amounts of from 0.1 to 20% by weight, such as from 0.5 to 1.5% by weight, such as from 1 to 10% by weight, in each case based on the total composition to enhance the oxidation/reduction performance of the cleaning solutions. The “nitrile quats”, cationic nitriles have the formula:

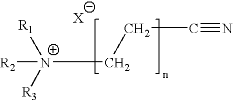

### G) Compounds Having Oxidation and Reduction Potential—from About 0.001% to 25% By Weight

These compounds include, but are not limited to, hydroxylamine and its salts, such as hydroxylamine chloride, hydroxylamine nitrate, hydroxylamine sulfate, hydroxylamine phosphate or its derivatives, such as N,N-diethylhydroxylamine, N-phenylhydroxylamine hydrazine and its derivatives; hydrogen peroxide; persulfate salts of ammonium, potassium and sodium, permanganate salt of potassium, sodium; and other sources of peroxide are selected from the group consisting of: perborate monohydrate, perborate tetrahydrate, percarbonate, salts thereof, and combinations thereof. For environmental reasons, hydroxylamine phosphate is not preferred.

Other compounds which may be used as ingredients within the scope of the present invention are the diacyl peroxides, such as, for example, dibenzoyl peroxide. Further typical organic compounds which have oxidation/reduction potentials are the peroxy acids, particular examples being the alkyl peroxy acids and the aryl peroxy acids. Exemplary representatives are (a) peroxybenzoic acid and its ring substituted derivatives, such as alkylperoxybenzoic acids, but also peroxy-a-naphthoic acid and magnesium monoperphthalate, (b) the aliphatic or substituted aliphatic peroxy acids, such as peroxylauric acid, peroxystearic acid, c-phthalimidoperoxycaproic acid [phthaloiminoperoxyhexanoic acid (PAP)], o-carboxybenzamidoperoxycaproic acid, N-nonenylamidoperadipic acid and N-nonenylamidopersuccinate, and (C) aliphatic and araliphatic peroxydicarboxylic acids, such as 1,2-diperoxycarboxylic acid, 1,9-diperoxyazelaic acid, diperoxysebacic acid, diperoxybrassylic acid, the diperoxyphthalic acids, 2-decyldiperoxvbutane-1,4-dioic acid, N,N-terephthaloyldi(6-aminopereaproic acid) may be used.

### H) Other Chelating Agents—In Exemplary Embodiments, the Cleaning Composition Comprises (By Weight of the Composition) from 0% to 15% of Additional One or More Chelant

A further possible group of components include chelate complexing agents. Chelate complexing agents are substances which form cyclic compounds with metal ions, where a single ligand occupies more than one coordination site on a central atom, i.e. is at least “bidentate”. In this case, stretched compounds are thus normally closed by complex formation via an ion to give rings. The number of bonded ligands depends on the coordination number of the central ion. Complexing groups (ligands) of customary complex forming polymers are iminodiacetic acid, hydroxyquinoline, thiourea, guanidine, dithiocarbamate, hydroxamic acid, amidoxime, aminophosphoric acid, (cycl.) polyamino, mercapto, 1,3-dicarbonyl and crown ether radicals, some of which have very specific activities toward ions of different metals

For the purposes of the present invention, it is possible to use complexing agents of the prior art. These may belong to different chemical groups. Representative chelating/complexing agents include, but are not limited to, the following, individually or in a mixture with one another:
1) polycarboxylic acids in which the sum of the carboxyl and optionally hydroxyl groups is at least 5, such as gluconic acid;
2) nitrogen-containing mono- or polycarboxylic acids, such as ethylenediaminetetraacetic acid (EDTA), N-hydroxyethylethylenediaminetriacetic acid, diethylenetriaminepentaacetic acid, hydroxy-ethyliminodiacetic acid, nitridodiacetic acid-3-propionic acid, isoserinediacetic acid, N,N-di(.beta.-hydroxyethyl)glycine, N-(1,2-dicarboxy-2-hydroxyethyl)glycine, N-(1,2-dicarboxy-2-hydroxyethyl)-aspartic acid or nitrilotriacetic acid (NTA);
3) geminal diphosphonic acids, such as 1-hydroxyethane-1,1-diphosphonic acid (HEDP), higher homologs thereof having up to 8 carbon atoms, and hydroxy or amino group-containing derivatives thereof and 1-aminoethane-1,1-diphosphonic acid, higher homologs thereof having up to 8 carbon atoms, and hydroxy or amino group-containing derivatives thereof;
4) aminophoshonic acids, such as ethylenediamin-tetra(methylenephosphonic acid), diethylenetriaminepenta(methylenephosphonic acid) or nitrilotri(methylenephosphonic acid);
5) phosphonopolycarboxylic acids, such as 2-phosphonobutane-1,2,4-tricarboxylic acid, and cyclodextrins.

### I) Surfactants—from About 10 ppm to 5%

Exemplary embodiments of the compositions according to the invention may also comprise anionic, cationic, and/or amphoteric surfactants as absurfactant component.

### J) Fluoride Ions—from an Amount About 0.001% to 10%

Sources of fluoride ions include, but are not limited to, ammonium bifluoride, ammonium fluoride, hydrofluoric acid, sodium hexafluorosilicate, fluorosilicic acid and tetrafluoroboric acid.

In exemplary embodiments, the components of the claimed compositions can be metered and mixed in situ just prior dispensing to the substrate surface for treatment. Furthermore, analytical devices can be installed to monitor the composition and chemical ingredients can be re-constituted to mixture to the specification to deliver the cleaning performance. Critical parameters that can be monitored include physical and chemical properties of the composition, such as pH, water concentration, oxidation/reduction potential and solvent components.

The composition claims a range at point of use and also as mixtures which can be diluted to meet the specific cleaning requirements.

While the invention has been described and illustrated herein by references to various specific materials, procedures and examples, it is understood that the invention is not restricted to the particular combinations of materials and procedures selected for that purpose. Numerous variations of such details can be implied as will be appreciated by those skilled in the art. It is intended that the specification and examples be considered as exemplary, only, with the true scope and spirit of the invention being indicated by the following claims. All references, patents, and patent applications referred to in this application are herein incorporated by reference in their entirety.

What is claimed is:

1. A cleaning composition comprising water and at least one amidoxime compound.

2. The composition of claim 1, wherein the at least one amidoxime compound is prepared from a nitrile compound.

3. The composition of claim 2, where in the nitrite compound is prepared from cyanoethylation of a compound selected from the group consisting of sugar alcohols, hydroxy acids, sugar acids, monomeric polyols, polyhydric alcohols, glycol ethers, polymeric polyols, polyalkylglycols, amines, amides, imides, amino alcohols, amino acids, and synthetic polymers containing at least one functional group that is —OH or —NHR, where R is H or alkyl, heteroalkyl, aryl or heteroaryl.

4. A method of applying a composition comprising water and an amidoxime compound to a semiconductor substrate, comprising contacting the substrate with the composition.

5. The method of claim 4, wherein the composition is applied to the semiconductor substrate as part of a CMP process.

6. The method of claim 4, wherein the composition is applied to the semiconductor substrate during a cleaning process.

7. The method of claim 4, wherein the composition is applied to the semiconductor substrate during a stripping process.

8. The method of claim 4, wherein pH is maintained to cause a passivating layer to form on the semiconductor substrate surface.

9. The method of claim 4, wherein the amidoxime compound is prepared from a nitrite compound.

10. The method of claim 9, wherein the nitrile compound is prepared from cyanoethylation of a compound selected from the group consisting of sugar alcohols, hydroxy acids, sugar acids, monomeric polyols, polyhydric alcohols, glycol ethers, polymeric polyols, polyethylene glycols polypropylene glycos, amines, amides, imides, amino alcohols, and synthetic polymers containing at least one functional group that is —OH or —NHR, where R is H or alkyl, heteroalkyl, aryl or heteroaryl.

11. A process for preparing a semiconductor surface comprising:
a. forming an aqueous mixture of a cyanoethylation catalyst and a nucleophile containing an alcohol or amine functionality;
b. adding an unsaturated nitrile to the mixture of step (a) and allowing the unsaturated nitrile to react with the alcohol or amine functionality to form a first aqueous solution;
c. adding a source of hydroxylamine to the first aqueous solution of step (b) to form a second solution; and
d. applying the second solution to a semiconductor surface containing copper.

12. The process of claim 11, wherein the nucleophile is alcohol selected from the group consisting of sorbitol, sucrose, pentaerythritol, glycols and mixtures thereof.

13. The process of claim 11, wherein the nucleophile is a primary or secondary amine having 1 to 30 carbon atoms.

14. The process of claim 11, wherein the source of hydroxylamine is hydroxylamine free base, hydroxylamine hydrochloride, hydroxylamine phosphate or hydroxylamine sulfate.

15. The process of claim 14, wherein the hydroxylamine free base is 50% solution in water.

16. The process of claim 11, wherein the cyanoethylation catalyst is lithium hydroxide, sodium hydroxide, potassium hydroxide, or tetraalkylammonium hydroxide.

17. The process of claim 16, wherein the tetraalkylammonium hydroxide is selected from tetramethylammonium hydroxide (TMAH), TMAH pentahydrate, benzyltrimethylammonium hydroxide (BTMAH) and tetrabutylammonium hydroxide (TBAH).

18. The process of claim 11, wherein the unsaturated nitrile is acrylonitrile.

19. A method of processing a wafer comprising
placing a wafer in a single wafer or batch cleaning tool and exposing the wafer to a cleaning solution comprising at least one amidoxime compound, wherein the wafer is exposed to the solution at a sufficient time and temperature to effectively remove surface residue and contaminants created during a semiconductor manufacturing process.

20. The method of claim 19 wherein the time is from approximately 30 seconds to 30 minutes.

21. The process of claim 19 wherein the temperature is from ambient temperature to 100° C.

22. The method of claim 19 wherein the composition comprises water that is introduced as a constituent of components of the composition.

23. The method of claim 19, wherein the amidoxime compound is present in an amount of about 0.001 to about 99 percent by weight.

24. The method of claim 19, wherein the cleaning solution further comprises an organic solvent in an amount up to about 99 percent by weight.

25. The method of claim 19, wherein the cleaning solution further comprises an acid in an amount of about 0.001 to about 45 percent by weight.

26. The method of claim 19, wherein the cleaning solution further comprises an activator in an amount of about 0.001 to about 25 percent by weight.

27. The method of claim 19, wherein the cleaning solution further comprises an additional chelating or complexing agent in an amount up to about 15 percent by weight.

28. The method of claim 19, wherein the cleaning solution further comprises a surfactant in an amount of about 10 ppm to about 5 percent by weight.

29. The method of claim 19, wherein the cleaning solution further comprises an organic solvent in an amount up to about 99 percent by weight; a base in an amount of about 1 to about 45 percent by weight; an activator in an amount of about 0.001 to about 25 percent by weight; an additional chelating or complexing agent in an amount up to about 15 percent by weight; and a surfactant in an amount of about 10 ppm to about 5 percent by weight.

30. A method of cleaning a wafer comprising: placing a wafer in a cleaning tool; and cleaning the wafer with a solution comprising; water, an amidoxime compound; an organic solvent in an amount up to about 99 percent by weight; optionally a base in an amount of about 1 to about 45 percent by weight; optionally a compound with an oxidation and reduction potential in an amount of about 0.001 to about 25 percent by weight; optionally an activator in an amount of about 0.001 to about 25 percent by weight; an additional chelating or complexing agent in an amount up to about 15 percent by weight; optionally a surfactant in an amount of about 10 ppm to about 5 percent by weight; and optionally a fluoride ion source in an amount of about 0.001 to about 10 percent by weight.

31. A method of cleaning a wafer comprising: placing a wafer in a cleaning tool; and cleaning the wafer with a solution comprising; water, an amidoxime compound; an organic solvent in an amount up to about 99 percent by weight; optionally an acid in an amount of about 0.001 to about 15 percent by weight; optionally a compound with oxidation and reduction potential in an amount of about 0.001 to about 25 percent by weight; optionally an activator in an amount of about 0.001 to about 25 percent by weight; an additional chelating or complexing agent in an amount up to about 15 percent by weight; optionally a surfactant in an amount of about 10 ppm to about 5 percent by weight; and optionally a fluoride ion source in an amount of about 0.001 to about 10 percent by weight.

32. The method of claim 30 or claim 31, wherein the cleaning tool is a single wafer processing or hatch processing tool.

33. The method of claim 19, wherein the cleaning solution comprising at least one amidoxime compound is further diluted prior to use.

34. The method of claim 33, wherein the dilution factor is from about 10 to 500.
